(19) United States
(12) Patent Application Publication
(10) Pub. No.: US 2025/0166112 A1
(43) Pub. Date: May 22, 2025

(54) IMAGE SIGNAL PROCESSOR

(71) Applicant: Samsung Electronics Co., Ltd., Suwon-si (KR)

(72) Inventors: Won Jin LEE, Suwon-si (KR); Ho Suk HAN, Suwon-si (KR)

(73) Assignee: Samsung Electronics Co., Ltd., Suwon-si (KR)

(21) Appl. No.: 18/890,065

(22) Filed: Sep. 19, 2024

(30) Foreign Application Priority Data
Nov. 21, 2023 (KR) 10-2023-0161721

(51) Int. Cl. G06T 1/20; G06T 1/60

(52) U.S. Cl. CPC G06T 1/20; G06T 1/60

(57) ABSTRACT

An image signal processor comprising a throttle buffer configured to receive image signals, and buffer and output the image signals; a module configured to receive the buffered image signals, perform calculations on the buffered image signals, and output calculated image signals; a splitter configured to receive the calculated image signals and send a portion of the received calculated image signal to a path; a buffer checking circuit configured output a stall counting enable signal at a logic high, in response to a ratio of a current usage capacity to a total capacity of the throttle buffer being greater than a ratio of a capacity of one line of the portion to the total capacity of the throttle buffer, based on a received memory status signal; and a stall counting circuit configured to count a stall signal input from the path, in response to receiving the stall counting enable signal.

### CROSS-REFERENCE TO RELATED APPLICATION

This application claims benefit of priority under 35 U.S.C. § 119 to Korean Patent Application No. 10-2023-0161721 filed on Nov. 21, 2023 in the Korean Intellectual Property Office, the contents of which is incorporated herein by reference in its entirety.

### BACKGROUND

The present inventive concepts relate to image signal processors.

An image signal processor may include a plurality of sub-function blocks that process an image signal. Each of the sub-function blocks may include modules that perform calculation on the image signal input to the image signal processor. An amount of the image signal input to the image signal processor may be large, such that the sub-function blocks or modules may not be able to quickly perform image processing or image calculation thereon. In this regard, if the image signal processor continues to receive the image signal from an image sensor, the image signal may become stuck within the image signal processor, and even an overflow may occur. Because the overflow may cause frame drop in the image signal processor, each of the sub-function blocks or the modules of the image signal processor may propagate a stall signal to a sub-function block or a module in front thereof.

In some example embodiments, if a stall counter that counts the stall signal within the image signal processor continues to count the stall signal in a situation where a possibility of overflow is not high, a discriminative ability of a stall counting value generated by the stall counter may be significantly reduced, which may result in excessive power consumption. For example, a reliability of the stall counting value indicating a possibility of the overflow may be low, and may result in excessive power consumption of the image signal processor.

### SUMMARY

A technical purpose of some example embodiments is to provide an image signal processor that includes a stall counter that generates a highly discriminative stall counting value.

Purposes according to the present inventive concepts are not limited to the above-mentioned purposes. Other purposes and advantages according to the present inventive concepts that are not mentioned may be understood based on following descriptions, and may be more clearly understood based on example embodiments according to the present inventive concepts. Further, it will be easily understood that the purposes and advantages according to the present inventive concepts may be realized using means shown in the claims or combinations thereof.

According to some example embodiments, there is provided an image signal processor comprising a first throttle buffer configured to receive first to third image signals from an image sensor, buffer the first to third image signals, and output the buffered first to third image signals, the first image signal including at least one first line; a first module configured to receive the first to third image signals, perform a first calculation on each of the first to third image signals, and output first to third calculated image signals corresponding to the first to third image signals, respectively; a first splitter configured to receive the first to third calculated image signals, split the first to third calculated image signals, and send the first calculated image signal to a first path; a first buffer checking circuit configured to receive a first memory status signal from the first throttle buffer including information about a capacity of the first line, a total capacity of the first throttle buffer, and a usage capacity of the first throttle buffer, and output a first stall counting enable signal at a logic high, in response to a ratio of the usage capacity of the first throttle buffer to the total capacity of the first throttle buffer being greater than a ratio of the capacity of the first line to the total capacity of the first throttle buffer; and a first stall counting circuit configured to count a first stall signal input from the first path, in response to receiving the first stall counting enable signal at a logic high.

According to some example embodiments, there is provided an image signal processor comprising a first throttle buffer configured to receive first to third image signals from an image sensor, buffer the first to third image signals, and output the buffered first to third image signals, the first image signal including an N-th line and an (N+1)-th line subsequent to the N-th line; a first module configured to receive the first to third image signals, perform a first calculation on each of the first to third image signals, and output first to third calculated image signals respectively corresponding to the first to third image signals; a first splitter configured to receive the first to third calculated image signals, split the first to third calculated image signals, and send the first calculated image signal to a first path; a throughput checking circuit configured to receive a period signal of the first image signal from the first throttle buffer including information about a first time-point at which the N-th line of the first image signal is input to the first throttle buffer and a second time-point at which the (N+1)-th line of the first image signal is input into the first throttle buffer, and a valid signal of the first image signal from the first throttle buffer including information about a third time-point at which the N-th line of the first image signal is output from the first throttle buffer, and output a first stall counting enable signal at a logic high, in response to the second time-point being earlier than the third time-point; and a first stall counting circuit configured to count a first stall signal input from the first path, in response to receiving the first stall counting enable signal at a logic high.

According to some example embodiments, there is provided an image signal processor comprising a throttle buffer configured to receive a first image signal from an image sensor, buffer the first image signal, and output the buffered first image signal; a first module configured to receive the first image signal, perform a first calculation on the first image signal to generate a second image signal, and output the second image signal; a first splitter configured to receive the second image signal, split the second image signal, and transmit a third image signal corresponding to part of the second image signal to a first path, the third image signal including an N-th line and an (N+1)-th line subsequent to the N-th line; a buffer checking circuit configured to receive a memory status signal from the throttle buffer including information about a capacity of one line included in the third image signal, a total capacity of the throttle buffer, and a usage capacity of the throttle buffer, and output a first stall counting enable signal at a logic high, in response to a ratio of the usage capacity of the throttle buffer to the total capacity of the throttle buffer being greater than a ratio of the capacity of one line included in the third image signal to the total capacity of the throttle buffer; a throughput checking circuit configured to receive a period signal of the third image signal from the throttle buffer including information about a first time-point at which the N-th line of the third image signal is input to the throttle buffer and a second time-point at which the (N+1)-th line of the third image signal is input to the throttle buffer, and a valid signal of the third image signal from the throttle buffer including information about a third time-point at which the N-th line of the third image is output from the throttle buffer, and output a second stall counting enable signal at a logic high, in response to the second time-point of the third image signal being earlier than the third-time point of the third image signal; and a stall counting circuit configured to count a stall signal input from the first path, in response to receiving one of the first stall counting enable signal at a logic high and the second stall counting enable signal at a logic high.

It should be noted that the effects of the present inventive concepts are not limited to those described above, and other effects of the present inventive concepts will be apparent from the following description.

Specific details of other example embodiments are included in the detailed description and drawings.

### BRIEF DESCRIPTION OF DRAWINGS

The above and other aspects and features of the present inventive concepts will become more apparent by describing in detail some example embodiments thereof with reference to the attached drawings, in which:

FIG. 1 is an example diagram illustrating an electronic device including an image signal processor according to some example embodiments.

FIG. 2 is an example diagram illustrating the image signal processor in FIG. 1 according to some example embodiments.

FIG. 3 is an example diagram illustrating the sub-IP included in the image signal processor in FIG. 2 according to some example embodiments.

FIG. 4 is an example diagram illustrating the image signal processor in FIG. 1 according to some example embodiments.

FIG. 5 is an example diagram illustrating the image signal input to the throttle buffer from the image sensor in FIG. 2 according to some example embodiments.

FIG. 6 is an example diagram illustrating a stall counting block according to some example embodiments.

FIG. 7 to FIG. 9 are example diagrams illustrating an operation of the stall counting block in FIG. 6 according to some example embodiments.

FIG. 10 is an example diagram illustrating a stall counting block according to some further example embodiments.

FIG. 11 is an example diagram illustrating an operation of the stall counting block in FIG. 10 according to some example embodiments.

FIG. 12 and FIG. 13 are example diagrams illustrating a stall counting block according to some further example embodiments.

FIG. 14 and FIG. 15 are example diagrams illustrating the operation of the stall counting block in FIG. 13 according to some example embodiments.

FIG. 16 and FIG. 17 are example diagrams illustrating stall counting blocks according to some further example embodiments.

FIG. 18 is an example diagram illustrating a system-on-chip included in an electronic device according to some example embodiments.

### DETAILED DESCRIPTIONS

Advantages and features of the present inventive concepts, and methods of achieving the advantages and features will become apparent with reference to some example embodiments described later in detail together with the accompanying drawings. However, example embodiments the present inventive concepts are not limited to the example embodiments described, but may be implemented in various different forms. Thus, these example embodiments are set forth only to describe the present inventive concepts more fully with reference to the accompanying drawings. As those of ordinary skill in the art would realize, the described example embodiments may be modified in various different ways, all without departing from the spirit or scope of the present inventive concepts.

Accordingly, the drawings and description are to be regarded as illustrative in nature and not restrictive. The same reference numbers in different drawings represent the same or similar elements, and as such perform similar functionality. Further, descriptions and details of well-known steps, operations, and elements are omitted for simplicity of the description. Furthermore, in the following detailed description of the present inventive concepts, numerous specific details are set forth in order to provide a thorough understanding of the present inventive concepts. However, it will be understood that the present inventive concepts may be practiced without these specific details. In other instances, well-known methods, procedures, components, and circuits have not been described in detail so as not to unnecessarily obscure aspects of the present inventive concepts. Examples of various example embodiments are illustrated and described further below. It will be understood that the description herein is not intended to limit the spirit and scope of the claims to the specific example embodiments described herein. On the contrary, the description is intended to cover alternatives, modifications, and/or equivalents as may be included within the spirit and scope of the present inventive concepts as defined by the appended claims.

Terminology used herein is directed to the purpose of describing some example embodiments and is not intended to be limiting of the present inventive concepts. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expressions such as “at least one of” when preceding a list of elements may modify the entire list of elements and may not modify the individual elements of the list. In interpretation of numerical values, an error or tolerance therein may occur even when there is no explicit description thereof.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain example embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

The features of the various example embodiments of the present inventive concepts may be partially or entirely combined with each other, and may be technically associated with each other or operate with each other. The example embodiments may be implemented independently of each other and may be implemented together in an association relationship.

Unless otherwise defined, all terms including technical and scientific terms used herein have the same meaning as commonly understood by one of ordinary skill in the art to which this inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an image signal processor according to some example embodiments will be described with reference to the attached drawings.

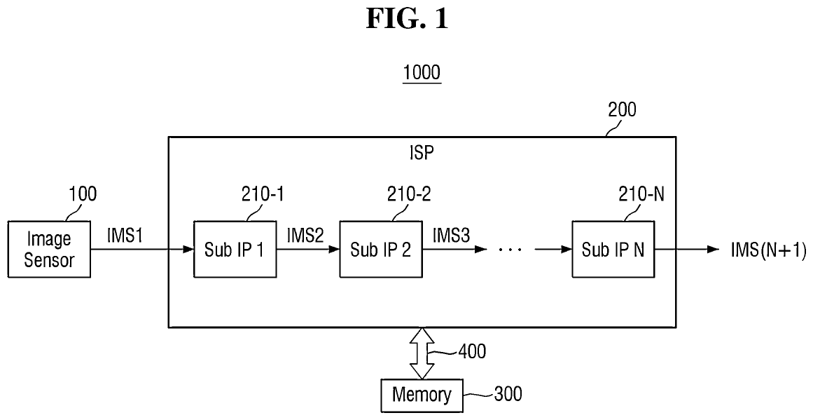

FIG. 1 is an example diagram illustrating an electronic device including an image signal processor according to some example embodiments.

First, referring to FIG. 1, an electronic device 1000 may include an image sensor 100, an image signal processor (ISP) 200, a bus 400, and a memory 300.

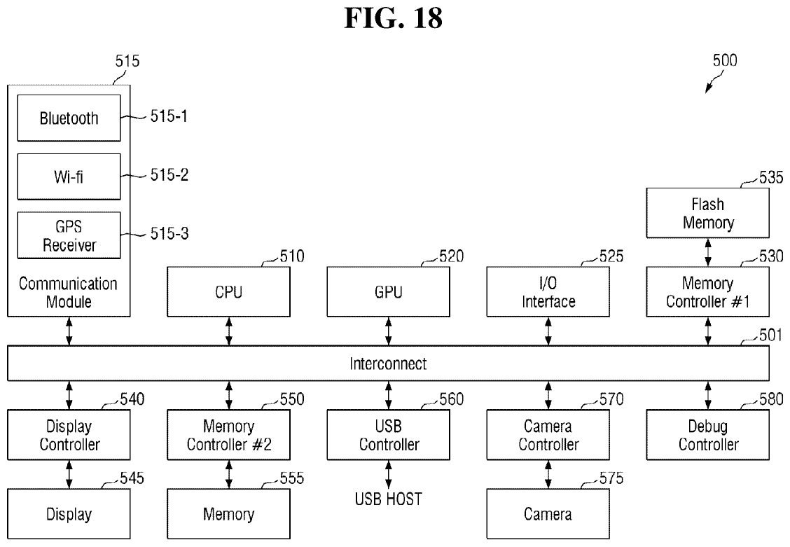

The electronic device 1000 may be a concept that encompasses all devices that may employ the image sensor 100, such as smartphones, tablet PCs, and digital cameras, but example embodiments are not limited thereto. The electronic device 1000 may include a (SOC) System-On-Chip. The system-on-chip of the electronic device 1000 may include the image sensor 100, the image signal processor 200, the memory 300, and the bus 400. However, example embodiments of the present inventive concepts are not limited thereto, and the system-on-chip of the electronic device 1000 may further include other configurations in addition to those shown in FIG. 1. For example, the system-on-chip of the electronic device 1000 may further include other functional blocks (Intellectual Property; IP) in addition to the image signal processor 200. The configuration of the system-on-chip of the electronic device 1000, according to some example embodiments, will be described later with reference to FIG. 18.

In some example embodiments, the image sensor 100 may generate an image signal IMS1 by converting light transmitted or sent from an object into an electrical signal. The image signal processor 200 may receive the image signal IMS1 from the image sensor 100, and may process the received image signal IMS1 to generate another image signal IMS2. For example, the image signal processor 200 may receive the image signal IMS1 output from the image sensor 100 of a camera mounted on the electronic device 1000, and may process the received image signal IMS1 so that other functional blocks included in the system-on-chip of the electronic device 1000 may easily recognize and process the processed image signal IMS1.

For example, the image signal processor 200 may perform (e.g., be configured to perform) digital binning on the image signal IMS1 output from the image sensor 100. For example, the image signal IMS1 output from the image sensor 100 may be a raw image signal output from a pixel array of the image sensor 100 which is not subjected to analog binning. Alternatively, in some example embodiments, the image signal IMS1 output from the image sensor 100 may be an image signal subjected to the analog binning.

The image signal processor 200 may include a plurality of sub-IPs 210-1, 210-2, . . . , 210-N. The plurality of sub-IPs 210-1, 210-2, . . . , 210-N is a sub concept of the image signal processor 200 and may be sub-blocks that perform an image processing process to process the image signal IMS1 received by the image signal processor 200 and finally output an image signal IMS (N+1). For example, the sub-IP 210-1 may be a sub-IP that first receives the image signal IMS1 from the image sensor 100, and may process the image signal IMS1 to output another image signal IMS2. The image signal IMS2 output from the sub-IP 210-1 may then be input to sub-IP 210-2. The sub-IP 210-2 may process the received image signal IMS2 to output another image signal IMS3.

In this way, the image signal IMS1 output from the image sensor 100 may be sequentially processed by the plurality of sub-IPs 210-1, 210-2, . . . , 210-N in the image signal processor 200. Then, the image signal IMS (N+1) may be finally output from the sub-IP 210-N positioned at a back end (where N is an integer greater than 1).

The bus 400 may be an interconnect connecting the image signal processor 200 and the memory 300 to each other. For example, the image signal processor 200 may access the memory 300 through the bus 400 and write data such as the image signal. For example, the data that the image signal processor 200 stores in the memory 300 may be an image signal output from one of the plurality of sub-IPs 210-1, 210-2, . . . , 210-N. Alternatively, in some example embodiments, the image signal processor 200 may access the memory 300 through the bus 400 and read data required for an operation of the image signal processor 200 among the data stored in the memory 300. For example, each of the plurality of sub-IPs 210-1, 210-2, . . . , 210-N may access the memory 300 through the bus 400 and may read the data required when processing the image signal. In some example embodiments, the memory 300 may be a volatile memory device or a non-volatile memory device.

FIG. 1 shows that the system-on-chip of the electronic device 1000 includes one image sensor 100 and one image signal processor 200. However, example embodiments of the present inventive concepts are not limited thereto. According to some example embodiments, each of the number of image sensors and the number of image signal processors included in the system-on-chip of the electronic device 1000 may be two or more.

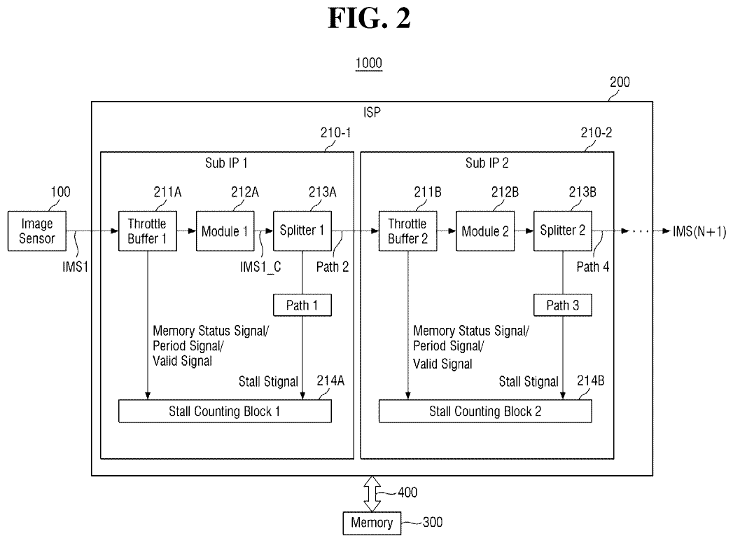

FIG. 2 is an example diagram illustrating the image signal processor in FIG. 1 according to some example embodiments.

FIG. 2 shows an example internal configuration of the sub-IP 210-1 and the sub-IP 210-2 among the plurality of sub-IPs 210-1, 210-2, . . . , 210-N in FIG. 1. However, each of the remaining sub-IPs 210-3, 210-4, . . . , 210-N may include the same or similar internal configuration as that of each of the sub-IP 210-1 and the sub-IP 210-2. Therefore, hereinafter, the descriptions of the remaining sub-IPs 210-3, 210-4, . . . , 210-N will be repositioned with the descriptions of the sub-IP 210-1 and the sub-IP 210-2.

First, referring to FIG. 2, the sub-IP 210-1 may include a throttle buffer 211A, a module 212A, a splitter 213A, and a stall counting block 214A. The sub-IP 210-2 may include a throttle buffer 211B, a module 212B, a splitter 213B, and a stall counting block 214B. The configuration of the sub-IP 210-2 is similar to that of the sub-IP 210-1. Thus, the following description focuses on the sub-IP 210-1. The configuration of the sub-IP 210-2 according to some example embodiments will be described based on differences from the configuration of the sub-IP 210-1.

The throttle buffer 211A may receive the image signal IMS1 from the image sensor 100, and buffer and output the received image signal IMS1. The sub-IP 210-1 may be a sub-IP positioned at a front end of the image signal processor 200. Thus, the throttle buffer 211A included in the sub-IP 210-1 may first receive the image signal IMS1 output from the image sensor 100.

In some example embodiments, there may be a plurality of image sensors 100. Accordingly, in some example embodiments, the image signal processor 200 may receive a plurality of image signals IMS1 respectively from the plurality of image sensors 100. Alternatively, in some example embodiments, the image signal processor 200 may receive a plurality of image signals IMS1 from one image sensor 100.

When, for example, one image signal processor 200 receives the plurality of image signals IMS1, the throttle buffer 211A may not immediately output the received image signal IMS1. Instead, the throttle buffer 211A may buffer the received image signal IMS1 and may output the stored image signal IMS1 after a sufficient time has elapsed. In some example embodiments, when an amount of the image signal IMS1 received by the throttle buffer 211A is not large, the throttle buffer 211A may output the received image signal IMS1 in real time, for example, may output the received image signal immediately without a buffering process.

The module 212A may receive the image signal output from the throttle buffer 211A and perform image calculation thereon. As a result, the calculated image signal IMS1_C may be output from the module 212A. For example, if there are a plurality of image signals received by the module 212A, the module 212A may perform calculation on each of the plurality of image signals and output a plurality of calculated image signals corresponding to the plurality of image signals.

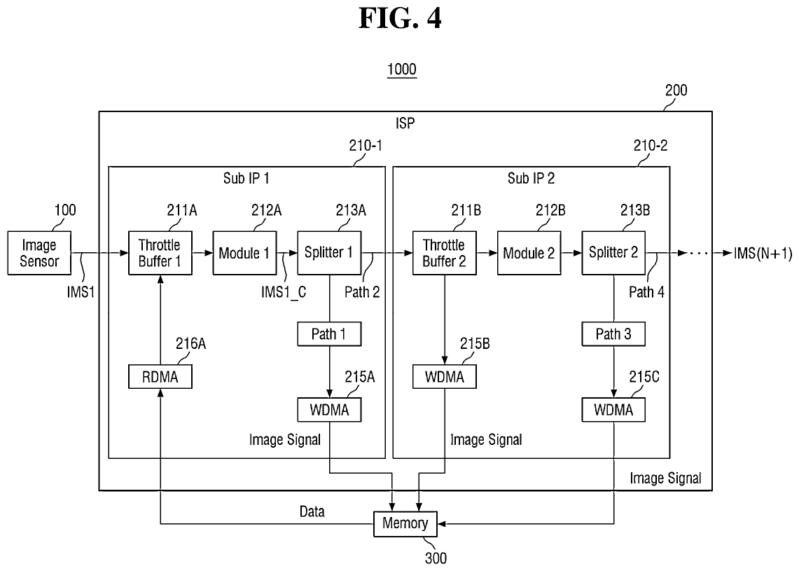

The calculated image signal IMS1_C output from the module 212A may be input to the splitter 213A. The splitter 213A may be a data splitter. Accordingly, the splitter 213A may transmit a portion of the received calculated image signal IMS1_C to a path Path 1, and may transmit the remaining portion to a path Path 2. The splitter 213A may transmit a data that needs to be stored in the memory 300 in the received calculated image signal IMS1_C to the path Path 1. Furthermore, the splitter 213A may transmit a data that is required or advantageous to be subjected to additional image calculation or additional image processing in the received calculated image signal IMS1_C to the path Path 2. Post-processing of the data transmitted to the path Path 1 in the calculated image signal output from the module 212A according to some example embodiments will be described later with reference to FIG. 4.

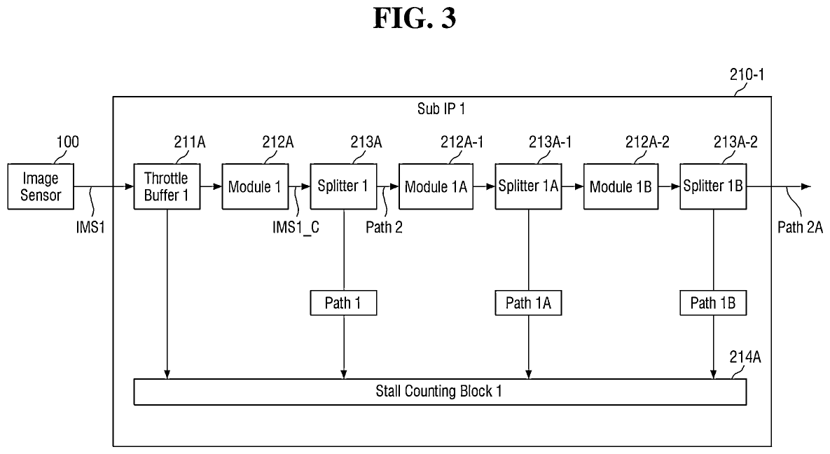

FIG. 2 shows that only one module 212A is included in the sub-IP 210-1. However, example embodiments of the present inventive concepts are not limited thereto. For example, the sub-IP 210-1 may further include at least one module that performs a different calculation from the calculation performed by the module 212A. Example embodiments in which the sub-IP 210-1 includes a plurality of modules will be described later with reference to FIG. 3.

In some example embodiments, when the image signal processor 200 receives the plurality of image signals IMS1 respectively from the plurality of image sensors 100, and the amount of the image signals IMS1 received by the throttle buffer 211A is large, an overflow phenomenon in which the module 212A positioned in rear of the throttle buffer 211A and configured to receive and process the image signals therefrom may occur. In some example embodiments, the sub-IP 210-2, or other sub-IPs (e.g., sub-IP 210-3, 210-4, . . . , 210-N, etc.) in rear of the sub-IP 210-2 cannot process the received image signals, and thus, accumulation of the input image signal may occur. This overflow phenomenon may cause frame drop in the electronic device 1000.

In some example embodiments, the module 212A positioned in the rear of the throttle buffer 211A and configured to receive and process the image signal therefrom, the sub-IP 210-2, or other sub-IPs (e.g., sub-IP 210-3, 210-4, . . . , 210-N, etc.) in rear of the sub-IP 210-2 may generate a stall signal stall. The stall signal may indicate that the amount of the image signal being input is large, and thus the image signal should be prevented from being further input thereto. In some example embodiments, the stall signal generated by the module or the sub-IP may be transmitted to a preceding module or sub-IP.

For example, the stall signal generated by the module 212A may be transmitted to the throttle buffer 211A. The throttle buffer 211B which has received the image signal from the splitter 213A through the path Path 2, and the module 212B positioned in rear thereof may generate the stall signal. The stall signal generated by the throttle buffer 211B may flow through the path Path 2, the splitter 213A, and the module 212A positioned in front of the throttle buffer 211B, and finally, to the throttle buffer 211A which has received the first image signal IMS1 from the image sensor 100. Likewise, in some example embodiments, the stall signal generated by the module 212B may flow through the preceding components such as the throttle buffer 211B, the splitter 213A, and the module 212A and finally to the throttle buffer 211A.

In some example embodiments, in the process of finally delivering the stall signal from the subsequent module or sub-IP to the preceding throttle buffer 211A, the stall signal may also be input to the stall counting block 214A through the path Path 1. For example, all or some of the stall signals output from the throttle buffer 211B or the module 212B of the sub-IP 210-2 or another sub-IP positioned in rear of the sub-IP 210-2 may be input into the stall counting block 214A through the path Path 1.

The stall counting block 214A may count the stall signal input through the path Path 1. The stall counting block 214A may not always count the stall signal input from the path Path 1, but may count the stall signal only when a specific condition is met.

In some example embodiments, the stall counting block 214A may receive a memory status signal Memory Status Signal from the throttle buffer 211A to determine whether a condition for counting the stall signal is met.

In some example embodiments, the stall counting block 214A determines whether the condition for counting the stall signal is met. Upon the determination that the condition for counting the stall signal is met, the stall counting block 214A may receive a period signal Period Signal and a valid signal Valid Signal of the image signal IMS1 from the throttle buffer 211A in order to count the stall signal. However, example embodiments of the present inventive concepts are not limited thereto. In some example embodiments, the period signal Period Signal and the valid signal Valid Signal of the image signal IMS1 may be output from the throttle buffer 211A and may then pass through the module 212A and the splitter 213A and through the path Path 1 into the stall counting block 214A.

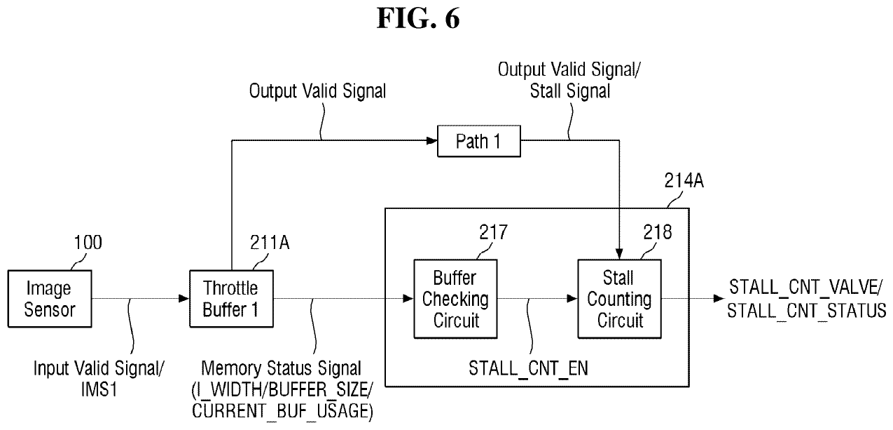

In some example embodiments, the stall counting block 214A may receive both the memory status signal Memory Status Signal, and the period signal Period Signal and the valid signal Valid Signal of the image signal IMS1. The stall counting block 214A, according to some example embodiments, will be described later with reference to FIG. 6.

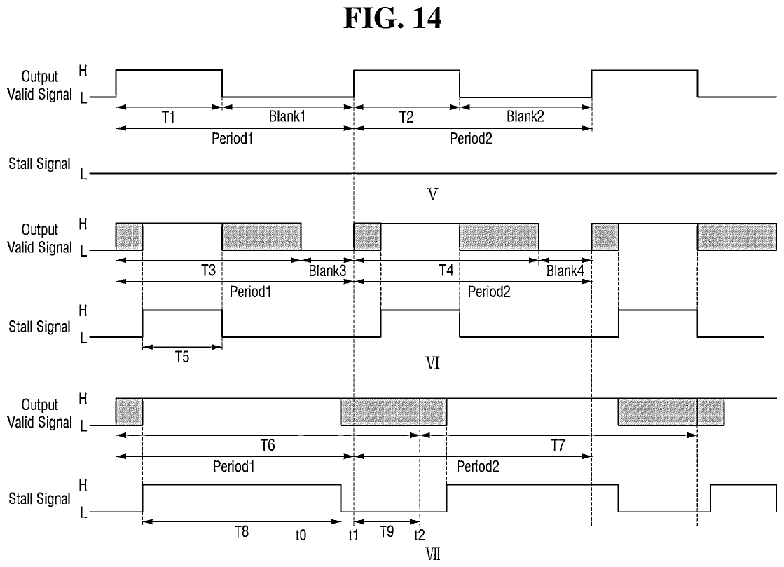

In some example embodiments, the period signal Period Signal and the valid signal Valid Signal that the stall counting block 214A receives from the throttle buffer 211A may be a period signal Period Signal and a valid signal Valid Signal of the image signal IMS1 input from the image sensor 100 to the throttle buffer 211A. However, in some example embodiments, the period signal Period Signal and the valid signal Valid Signal that the stall counting block 214A receives from the throttle buffer 211A may be a period signal Period Signal and a valid signal Valid Signal of the image signal output from the throttle buffer 211A through buffering of the image signal IMS1 input to the throttle buffer 211A. The period signal Period Signal and the valid signal Valid Signal of the image signal output from the throttle buffer 211A, according to some example embodiments, will be described later with reference to FIG. 14, etc.

FIG. 3 is an example diagram illustrating the sub-IP included in the image signal processor in FIG. 2 according to some example embodiments.

FIG. 3 is an example diagram illustrating an example embodiment in which the sub-IP 210-1 of FIG. 2 includes a plurality of modules and a plurality of splitters. Hereinafter, the sub-IP 210-1 in FIG. 2 is described by way of example. However, following descriptions may also be applied to the sub-IP 210-2 in FIG. 2.

Referring to FIG. 3, the sub-IP 210-1 may include modules 212A, 212A-1, and 212A-2 that perform different calculations, and splitters 213A, 213A-1, and 213A-2 that split the calculated image signals respectively output from the modules 212A, 212A-1, and 212A-2. For example, when the sub-IP 210-1 further includes module 212A-1 that performs a different calculation from a calculation performed by the module 212A, the module 212A-1 may receive a calculated image signal IMS1_C through the path Path 2 and may perform a calculation different from the calculation performed by the module 212A on the received calculated image signal IMS1_C. In some example embodiments, the calculated image signal subjected to the calculation of the module 212A-1 and output from the module 212A-1 may be input to the splitter 213A-1. The splitter 213A-1 may split the calculated image signal received therefrom such that a portion of the calculated image signal may be transmitted to a path Path 1A different from the path Path 1 within the sub-IP 210-1, while the remainder of the calculated image signal may be transmitted to the module 212A-2.

The module 212A-2 may perform a calculation different from each of the calculation performed by the module 212A and the calculation performed by the module 212A-1. Similarly, the calculated image signal subjected to the calculation of the module 212A-2 and output from the module 212A-2 may be input to the splitter 213A-2, and then, the splitter 213A-2 may split the calculated image signal received therefrom such that a portion of the calculated image signal may be transmitted to a path Path 1B different from the paths Path 1 and Path 1A within the sub-IP 210-1, while the remainder of the calculated image signal may be transmitted through the path Path 2A to the sub-IP 210-2.

In a process in which the image signal input from the image sensor 100 to the throttle buffer 211A passes through the modules 212A, 212A-1, and 212A-2 and the splitters 213A, 213A-1, and 213A-2 as described above to the IP 210-2, a phenomenon (e.g., a so-called “stuck” phenomenon) in which the image signal becomes stuck in a certain section may occur. If this stuck phenomenon worsens, an overflow phenomenon as one of the causes of frame drop in the electronic device 1000 (e.g., shown in FIG. 1) may occur.

According to some example embodiments, to prevent the overflow phenomenon, each of the modules 212A, 212A-1, and 212A-2 may generate the stall signal. The stall signals generated by each of the modules 212A, 212A-1, and 212A-2 included in the sub-IP 210-1 and the stall signals generated by other sub-IPs (for example, the sub-IP 210-2) in rear of the sub-IP 210-1 may be finally delivered to the throttle buffer 211A.

In some example embodiments, in a process of transmitting the stall signal to the throttle buffer 211A from the modules 212A, 212A-1, and 212A-2 of the sub-IP 210-1 or the other sub-IPs other than the sub-IP 210-1, the stall signal may be transmitted to the paths Path 1, Path 1A, Path 1B inside the sub-IP 210-1. For example, when the stall signal generated from the module 212A-1 or the module 212A-2 in rear of the splitter 213A, or the sub-IP (for example, the sup-IP 210-2) in rear of the sub-IP 210-1 is transmitted through the splitter 213A to the throttle buffer 211A, the stall signal may be transmitted from the splitter 213A through the path Path 1 to the stall counting block 214A.

Furthermore, in some example embodiments, when the stall signal generated from the module 212A-2 positioned in rear of the splitter 213A-1 or the sub-IP (e.g., the sub-IP 210-2) positioned in rear of the sub-IP 210-1 is transmitted through the splitter 213A-1 to the throttle buffer 211A, the stall signal may be transmitted from the splitter 213A-1 through the path Path 1A to the stall counting block 214A. Similarly, in some example embodiments, when the stall signal generated from the sub-IP (e.g., the sub-IP 210-2 positioned in rear of the splitter 213A-2) is transmitted through the splitter 213A-2 to the throttle buffer 211A, the stall signal may be transmitted from the splitter 213A-2 through the path Path 1B to the stall counting block 214A.

However, example embodiments of the present inventive concepts are not limited thereto, and each stall signal input to the stall counting block 214A through each of the paths Path 1, Path 1A, and Path 1B within the sub-IP 210-1 may include the stall signal generated from the module positioned in front of each of the splitters 213A, 213A-1, and 213A-2 connected to each of the paths Path 1, Path 1A, and Path 1B. For example, the stall signal input to the stall counting block 214A through the path Path 1 may include the stall signal generated from the module 212A. The stall signal input to the stall counting block 214A through the path Path 1A may include the stall signal generated from the module 212A and/or the module 212A-1. Likewise, the stall signal input to the stall counting block 214A through the path Path 1B may include the stall signal generated from the module 212A, the module 212A-1, and/or the module 212A-2.

Next, referring to FIG. 4, in some example embodiments, the sub-IP 210-1 may include a RDMA (Read Direct Memory Access) 216A, and a WDMA (Write Direct Memory Access) 215A. The sub-IP 210-2 may include a WDMA 215B and a WDMA 215C.

A type and the number of DMAs included in each of the sub-IP 210-1 and the sub-IP 210-2 shown in FIG. 4 are only examples. According to some example embodiments, the type and the number of DMAs included in each of the sub-IP 210-1 and the sub-IP 210-2 may vary. For example, the sub-IP 210-2 may include a RDMA, and the number of WDMAs included in the sub-IP 210-1 may be more than one. However, hereinafter, for convenience of description, example embodiments in which the sub-IP 210-1 includes one RDMA 216A and one WDMA 215A, and the sub-IP 210-2 includes two WDMAs 215B and 215C is described.

When the sub-IP 210-2 performs a write operation into the memory 300, the sub-IP 210-2 may access the memory 300 through the WDMAs 215B and 215C. For example, when the sub-IP 210-2 writes the image signal buffered in the throttle buffer 211B to the memory 300, the sub-IP 210-2 may transmit the image signal to the memory 300 using the WDMA 215B without intervention of a CPU (Central Processing Unit). In some example embodiments, a portion to be stored in the memory 300 of the calculated image signal output from the splitter 213B may be transmitted to the memory 300 through the path Path 3 by the WDMA 215C without intervention of a CPU (Central Processing Unit).

In some example embodiments, the calculated image signal transmitted from the splitter 213A of the sub-IP 210-1 to the path Path 1 may be transmitted to the memory 300 by the WDMA 215A without CPU intervention. In some example embodiments, data required for an operation such as image processing of the sub-IP 210-1 may be transferred from the memory 300 to throttle buffer 211A by the RDMA 216A without CPU intervention. For example, the data stored in the memory 300 may be transferred from the memory 300 to the throttle buffer 211A by the RDMA 216A in non-real time.

For example, the image signal transmitted from the image sensor 100 to the image signal processor 200 may be input to the throttle buffer 211A in real time. However, the sub-IP 210-1 may read the image signal stored in the memory 300 using the RMDA 216A in non-real time only when it is necessary or may be needed for the sub-IP 210-1 to read the image signal stored in the memory 300. For example, when the sub-IP 210-1 needs to quickly read the image signal stored in the memory 300, the sub-IP 210-1 may quickly read the image signal stored in the memory 300 using the RMDA 216A. Alternatively, in some example embodiments, when it is advantageous or when it is preferred for the sub-IP 210-1 to quickly read the image signal stored in the memory 300, the sub-IP 210-1 may quickly read the image signal stored in the memory 300 using the RDMA 216A. Conversely, in some example embodiments, when the sub-IP 210-1 does not need to quickly read the image signal stored in the memory 300, the sub-IP 210-1 may read relatively slowly the image signal stored in the memory 300 using the RMDA 216A. Alternatively, in some example embodiments, when it is not advantageous or when it is not preferred for the sub-IP 210-1 to quickly read the image signal stored in the memory 300, the sub-IP 210-1 may read the image signal stored in the memory 300 relatively slowly using the RMDA 216A. Accordingly, in some example embodiments, when the sub-IP 210-1 includes the RDMA 216A, a throughput of the throttle buffer 211A may be adjusted due to a non-real time feature of the RDMA 216A.

In some example embodiments, a portion of a total capacity of the throttle buffer 211A may be a capacity dedicated to the RDMA 216A. The capacity dedicated to the RDMA 216A of the total capacity of the throttle buffer 211A may be a usage capacity of the throttle buffer 211A for controlling the throughput of the RDMA 216A of the total capacity of the throttle buffer 211A. For example, a ratio of the capacity dedicated to the RDMA 216A of the total capacity of the throttle buffer 211A may be 30% of the total capacity of the throttle buffer 211A.

In some example embodiments, the capacity dedicated to the RDMA 216A is set to 30% of the total capacity of the throttle buffer 211A. For example, when the sub-IP 210-1 reads the data from the memory 300 using the RDMA 216A, the usage capacity of the throttle buffer 211A may increase to 30% of the total capacity of the throttle buffer 211A. However, if the usage capacity of the throttle buffer 211A exceeds 30% of the total capacity of the throttle buffer 211A, the sub-IP 210-1 may not read the image signal from the memory using the RDMA 216A and may stop the read operation. In some example embodiments, while the read operation is stopped, the data stored in the throttle buffer 211A may be output from the throttle buffer 211A, such that the usage capacity of the throttle buffer 211A is lowered to 30% or smaller of the total capacity of the throttle buffer 211A. Then, the sub-IP 210-1 may resume the operation of reading the image signal from the memory using the RDMA 216A.

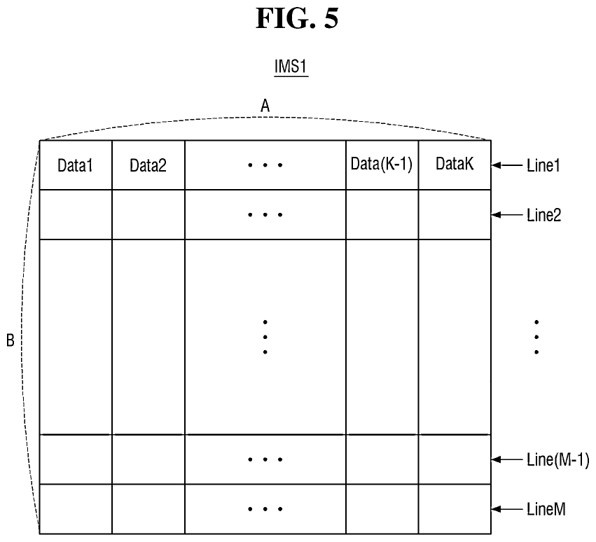

FIG. 5 is an example diagram illustrating the image signal input to the throttle buffer from the image sensor in FIG. 2 according to some example embodiments.

Referring to FIG. 5, a resolution of the image signal IMS1 may be determined based on a size of the image signal IMS1. For example, assuming that a longitudinal length of the image signal IMS1 is A and a transverse length thereof is B, A×B may indicate the resolution of the image signal IMS1. In some example embodiments, the resolution of the image signal IMS1 may be related to a capacity of the image signal IMS1. The image signal IMS1 may include a plurality of lines. For example, the image signal IMS1 may include M lines Line1, Line2, . . . , LineM−1, LineM where M is an integer of 1 or greater. Each of the lines Line1, Line2, . . . , LineM−1, LineM of the image signal IMS1 may include data. For example, one line of the image signal IMS1 may include K pieces of data Data1, Data2, . . . , DataK−1, DataK where K is an integer greater than or equal to 1.

When the image signal IMS1 is input to the throttle buffer 211A from the image sensor 100, the image signal IMS1 may be sequentially input to the throttle buffer 211A on a line basis. For example, all of K pieces of data Data1, Data2, . . . , DataK−1, DataK included in the first line Line1 of the image signal IMS1 may be sequentially input to the throttle buffer 211A, and then K pieces of data Data1, Data2, . . . , DataK−1, DataK included in the second line Line2 may be sequentially input into the throttle buffer 211A. Accordingly, in some example embodiments, the M lines included in the image signal IMS1 output from the image sensor 100 may be sequentially input to the throttle buffer 211A.

According to some example embodiments, a capacity of a line of the image signal IMS1 may mean the longitudinal length of the image signal IMS1. For example, A as the longitudinal length of the image signal IMS1 may correspond to the capacity of each of the lines Line1, Line2, . . . , LineM−1, LineM included in the image signal IMS1.

FIG. 6 is an example diagram illustrating a stall counting block according to some example embodiments.

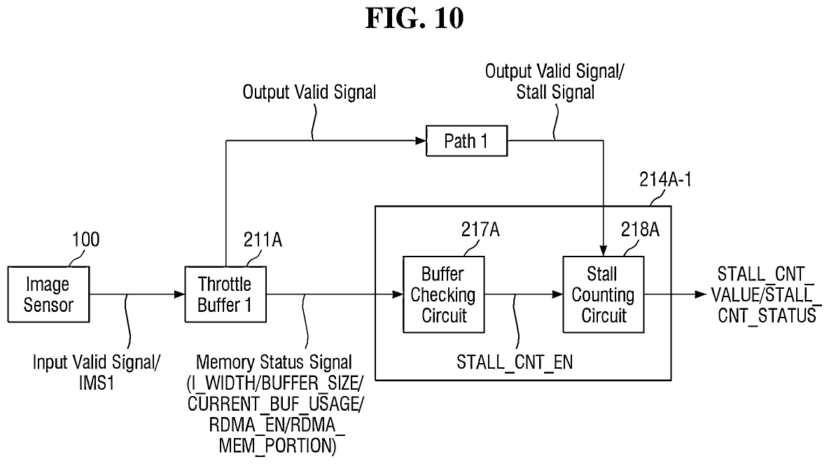

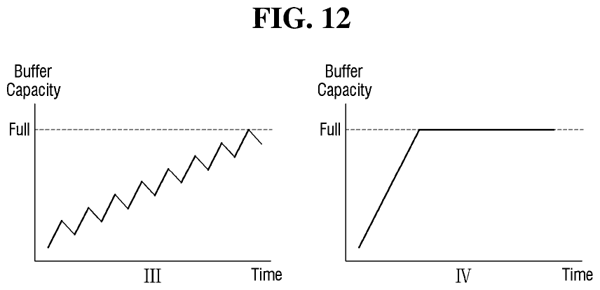

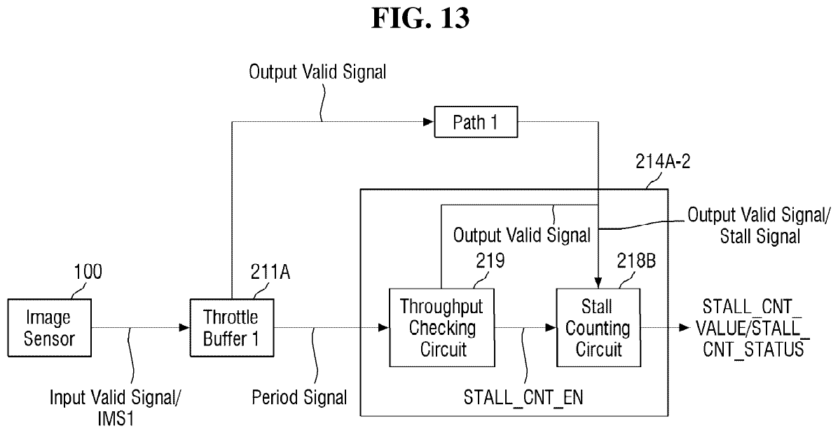

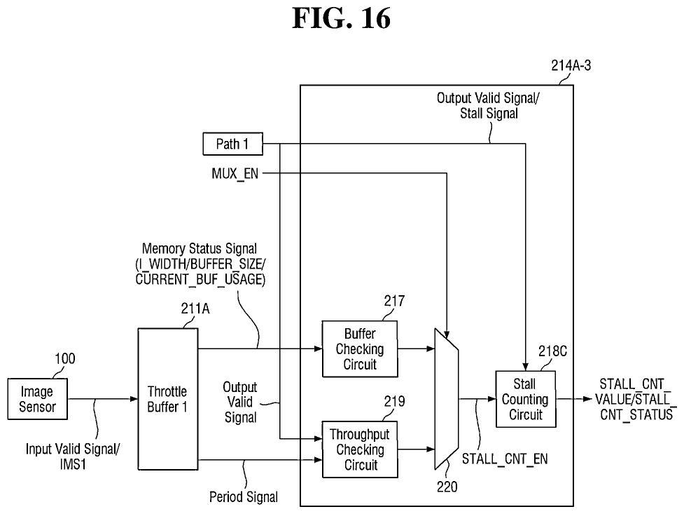

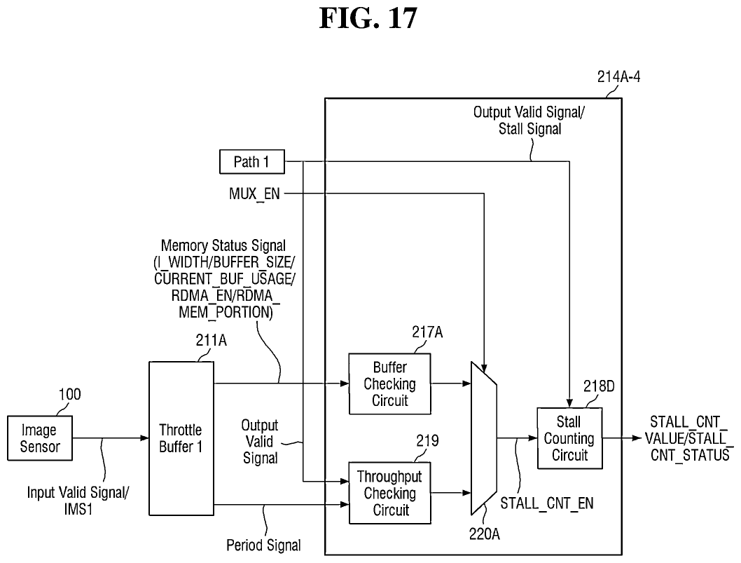

Each of the stall counting blocks 214A, 214B, etc. included in each of the plurality of sub-IPs 210-1, 210-2, . . . , 210-N of the image signal processor 200 as shown in FIG. 2 may be embodied as one of the stall counting blocks as shown in FIG. 6, FIG. 10, FIG. 12, FIG. 13, FIG. 16, and FIG. 17. Hereinafter, in FIG. 6, FIG. 10, FIG. 12, FIG. 13, FIG. 16, and FIG. 17, the stall counting block 214A in FIG. 2 is described as an example according to some example embodiments. The following description applies equally to other stall counting blocks 214B, etc. included in each of the plurality of sub-IPs 210-1, 210-2, . . . , 210-N of the image signal processor 200.

The stall counting block 214A may include a buffer checking circuit 217 and a stall counting circuit 218. The buffer checking circuit 217 may receive the memory status signal Memory Status Signal from the throttle buffer 211A. The memory status signal Memory Status Signal may include information about a capacity I_WIDTH of one line of the image signal IMS1 input from the image sensor 100 to the throttle buffer 211A, a total capacity BUFFER_SIZE of the throttle buffer 211A, and a current usage capacity CURRENT_BUF_USAGE of the throttle buffer 211A. The buffer checking circuit 217 may output a stall counting enable signal STALL_CNT_EN based on the memory status signal Memory Status Signal.

For example, the buffer checking circuit 217 may output the stall counting enable signal STALL_CNT_EN at a logic high, in response to that a ratio of the current usage capacity CURRENT_BUF_USAGE of the throttle buffer 211A to the total capacity BUFFER_SIZE of the throttle buffer 211A is greater than a ratio of the capacity I_WIDTH of one line of the image signal IMS1 to the total capacity BUFFER_SIZE of the throttle buffer 211A, based on the information included in the received memory status signal Memory Status Signal. Conversely, in some example embodiments, the buffer checking circuit 217 may output the stall counting enable signal STALL_CNT_EN at a logic low, in response to that the ratio of the capacity I_WIDTH of one line of the image signal IMS1 to the total capacity BUFFER_SIZE of the throttle buffer 211A is greater than the ratio of the current usage capacity CURRENT_BUF_USAGE of the throttle buffer 211A to the total capacity BUFFER_SIZE of the throttle buffer 211A, based on the information included in the received memory status signal Memory Status Signal.

The stall counting circuit 218 may receive the stall counting enable signal STALL_CNT_EN from the buffer checking circuit 217. When the stall counting enable signal STALL_CNT_EN is at a logic high, the stall counting circuit 218 may be enabled to count the stall signal Stall Signal input from the path Path 1. Conversely, in some example embodiments, when the stall counting enable signal STALL_CNT_EN is at a logic low, the stall counting circuit 218 may not be enabled and thus may not count the stall signal Stall Signal.

In some example embodiments, when the stall counting circuit 218 receives the stall counting enable signal STALL_CNT_EN at a logic high, the stall counting circuit 218 may count the stall signal received through the path Path 1. As described above, the stall signal Stall Signal transmitted to the stall counting block 214A through the path Path 1 may be a stall signal transmitted from the module or the sub-IP positioned in front of and/or in rear of the splitter 213A (e.g., shown in FIG. 2).

The stall counting circuit 218 may receive an output valid signal Output Valid Signal along with a stall signal Stall Signal through the path Path 1. The output valid signal Output Valid Signal may be a signal output from the throttle buffer 211A. The output valid signal Output Valid Signal may be output from the throttle buffer 211A and input into the stall counting circuit 218 through the path Path 1. However, example embodiments of the present inventive concepts are not limited thereto. According to some example embodiments, the output valid signal Output Valid Signal may be output from the throttle buffer 211A and then input into the stall counting circuit 218 without passing through the path Path 1.

According to some example embodiments, a valid signal Valid Signal may include an input valid signal Input Valid Signal and an output valid signal Output Valid Signal. The input valid signal Input Valid Signal may be a signal that is input to the throttle buffer 211A together with the image signal IMS1 when the image signal IMS1 is input to the throttle buffer 211A from the image sensor 100. The output valid signal Output Valid Signal may be a signal output from the throttle buffer 211A together with the image signal IMS1 output from the throttle buffer 211A when the image signal IMS1 input from the image sensor 100 to the throttle buffer 211A is output through the throttle buffer 211A.

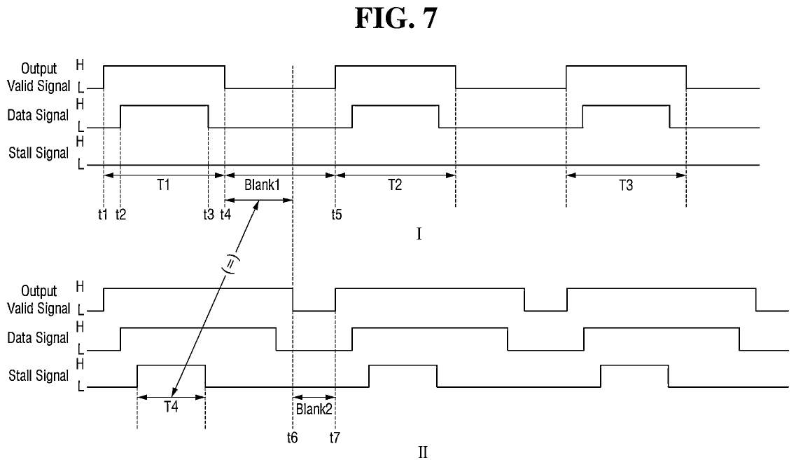

The valid signal Valid Signal may be a preemptive signal that indicates whether the image signal IMS1 is a valid signal containing data. For example, when the throttle buffer 211A receives the input valid signal Input Valid Signal, the throttle buffer 211A may know that the image sensor 100 will transmit the image signal IMS1 containing data. Likewise, when the throttle buffer 211A outputs the output valid signal Output Valid Signal, and thus the WDMA 215A (e.g., shown in FIG. 4) receives the output valid signal Output Valid Signal, the WDMA 215A (e.g., shown in FIG. 4) may know that the calculated image signal IMS1_C (e.g., shown in FIG. 2) will be input thereto. The valid signal Valid Signal, according to some example embodiments, will be described later with reference to FIG. 7.

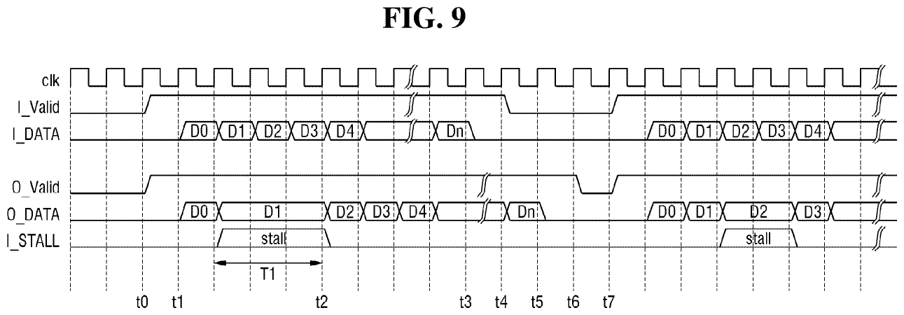

In response to receiving the stall counting enable signal STALL_CNT_EN at a logic high, the stall counting circuit 218 may count the stall signal Stall Signal and may output a stall counting value STALL_CNT_VALUE and a stall counting status signal STALL_CNT_STATUS, based on the counting of the stall signal Stall Signal. The stall counting value STALL_CNT_VALUE may mean the number of stall signals Stall Signal counted by the stall counting circuit 218. As will be described later with reference to FIG. 9, etc., the stall counting circuit 218 may count the stall signal based on a clock signal according to some example embodiments.

The stall counting status signal STALL_CNT_STATUS may include information about whether the stall counting circuit 218 has counted the stall signal Stall Signal. For example, when the stall counting circuit 218 receives the stall counting enable signal STALL_CNT_EN at a logic high and thus counts the stall signal Stall Signal, the stall counting circuit 218 may output the stall counting status signal STALL_CNT_STATUS at a logic high. Conversely, if the stall counting circuit 218 receives the stall counting enable signal STALL_CNT_EN at a logic low and thus does not count the stall signal Stall Signal, the stall counting circuit 218 may output the stall counting status signal STALL_CNT_STATUS at a logic low.

In some example embodiments, when debugging the electronic device 1000, each of the plurality of sub-IPs 210-1, 210-2, . . . , 210-N included in the image signal processor 200 may check the stall counting status signal STALL_CNT_STATUS generated by each of the stall counting blocks included in each of the plurality of sub-IPs 210-1, 210-2, . . . , 210-N. In some example embodiments, the sub-IPs that are outputting the stall counting status signal STALL_CNT_STATUS at a logic high may be determined, and then the stall counting values STALL_CNT_VALUE output from the determined sub-IPs may be compared to each other. Then, the sub-IP that is outputting a higher stall counting value STALL_CNT_VALUE based on the comparing result may be first checked. Accordingly, in some example embodiments, debugging may be done.

FIG. 7 to FIG. 9 are example diagrams illustrating an operation of the stall counting block in FIG. 6 according to some example embodiments.

Referring to FIG. 7, each of I and II is a timing diagram showing the output valid signal Output Valid Signal output from the throttle buffer 211A, a data signal Data Signal output from the throttle buffer 211A, and the stall signal Stall Signal input to the throttle buffer 211A. The data signal Data Signal output from the throttle buffer 211A may be included in the image signal IMS1 output from the throttle buffer 211A. For example, the data signal Data Signal may mean the data Data1, Data2, . . . , DataK−1, DataK included in the image signal IMS1 in FIG. 5.

When each of the output valid signals Output Valid Signal, the data signal Data Signal, and the stall signal Stall Signal is at a logic high, the output valid signals Output Valid Signal, and the data signal Data Signal may be output from the throttle buffer 211A, and the stall signal Stall Signal may be input into the throttle buffer 211A. When each of the output valid signals Output Valid Signal, the data signal Data Signal, and the stall signal Stall Signal is at a logic low, the output valid signals Output Valid Signal, and the data signal Data Signal may not be output from the throttle buffer 211A, and the stall signal Stall Signal may not be input into the throttle buffer 211A.

First, referring to I, each of a first interval T1, a second interval T2, and a third interval T3 for which the output valid signal Output Valid Signal is at a logic high may correspond to one line of the image signal IMS1. For example, referring to I together with FIG. 5, the first interval T1 for which the output valid signal Output Valid Signal is at a logic high may correspond to the first line Line1 of the image signal IMS1. Next, the second interval T2 for which the output valid signal Output Valid Signal is at a logic high may correspond to the second line Line2 of the image signal IMS1, and then the third interval T3 for which the output valid signal Output Valid Signal is at a logic high may correspond to the third line Line3 of the image signal IMS1. FIG. 7 shows only a portion of the valid signal output from the throttle buffer 211A according to some example embodiments. When, for example, as shown in FIG. 5, the image signal IMS1 includes a total of M lines, there may be a total of M intervals for which the output valid signal Output Valid Signal is at a logic high.

An interval for which the data signal Data Signal is at a logic high may be included in a time-interval for which the output valid signal Output Valid Signal is at a logic high. For example, the output valid signal Output Valid Signal may be a preemptive signal that indicates whether the image signal IMS1 is a valid signal containing data. regarding some example embodiments, a time-point t1 at which the output valid signal Output Valid Signal transitions from a logic low to a logic high may coincide with or be earlier than a time-point t2 at which the data signal Data Signal transitions from a logic low to a logic high. Furthermore, a time-point t4 at which the output valid signal Output Valid Signal transitions from a logic high to a logic low may coincide with or be later than a time-point t3 at which the data signal Data Signal transitions from a logic high to logic low.

For example, for the time-interval for which the output valid signal Output Valid Signal is at a logic high, the data included in each line of the image signal may be output from the throttle buffer 211A. An interval from the time-point t4 at which the output valid signal Output Valid Signal corresponding to the first line Line1 of the image signal IMS1 transitions from a logic high to logic low to the time-point t5 when the output valid signal Output Valid Signal corresponding to the second line Line2 of the image signal IMS1 transitions from a logic low to a logic high may be defined as a blank interval Blank1. When there is no stall signal input to the throttle buffer 211A, there may be the blank interval Blank1 between the first interval T1 corresponding to the first line Line1 of the image signal IMS1 and the second interval T2 corresponding to the second line Line2 of the image signal IMS1.

Next, in some example embodiments, unlike I in FIG. 7, referring to II in FIG. 7, the stall signal Stall Signal may be input to the throttle buffer 211A. When the stall signal is input to the throttle buffer 211A, the throttle buffer 211A may not output the data signal Data Signal for the time-interval T4 for which the stall signal Stall Signal is at a logic high. For example, as shown in FIG. 5, an amount of the data included in one line of the image signal IMS1 is set. Therefore, as shown in FIG. 7, a time-point t6 at which the throttle buffer 211A completes outputting of the output valid signal Output Valid Signal may be delayed by a time amount for which the throttle buffer 211A does not output the data signal Data Signal while the stall signal Stall Signal is input to the throttle buffer 211A.

Accordingly, in some example embodiments, due to the stall signal Stall Signal input to the throttle buffer 211A, the time-point t6 at which the output valid signal Output Valid Signal transitions from a logic high to a logic low is delayed, such that a temporal length of a blank interval Blank2 between the time-point t6 and a time-point t7 at which the output valid signal Output Valid Signal corresponding to the second line Line2 of the image signal IMS1 is output from the throttle buffer 211A may be smaller than a temporal length of the blank interval Blank1 in I in which there is no stall signal input to the throttle buffer 211A. However, in some example embodiments, even when the temporal length of the blank interval Blank2 in II is reduced, when a temporal length of a time-interval (for example, a temporal length of the time-interval T4) of the stall signal Stall Signal in II is smaller than a temporal length of the blank interval Blank1 in I in which there is no stall signal input to the throttle buffer 211A, a possibility at which the overflow may occur may be small. In other words, even when the stall signal Stall Signal is input to the throttle buffer 211A such that the output of the data signal Data Signal is delayed, when a certain temporal length of the blank interval is secured, the data may be sufficiently processed (for example, a sufficient time for which the image signal IMS1 may be output from the throttle buffer 211A may be secured) for the blank interval Blank2, before the time-point t7 at which the output valid signal Output Valid Signal corresponding to the second line Line2 of the image signal IMS1 transitions from a logic low to a logic high.

Therefore, as shown in FIG. 7, even when a temporal length of a time-interval (for example, a temporal length of the time-interval T4) of the stall signal Stall Signal in II is smaller than a temporal length of the blank interval Blank1 in I in which there is no stall signal input to the throttle buffer 211A, the stall counting circuit 218 (e.g., shown in FIG. 6) counts the stall signal. For example, although the stall counting value STALL_CNT_VALUE output by the stall counting circuit 218 is high, the possibility at which the overflow phenomenon may actually occur is low. Thus, the reliability of the stall counting value STALL_CNT_VALUE may be low.

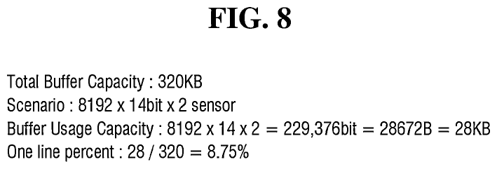

Next, referring to FIG. 8, FIG. 8 shows a diagram of an example in which the buffer checking circuit 217 (e.g., shown in FIG. 6) outputs the stall counting enable signal STALL_CNT_EN at a logic high, based on the memory status signal Memory Status Signal, in order to increase the reliability of the stall counting value STALL_CNT_VALUE according to some example embodiments.

For example, it may be assumed that the total capacity of the throttle buffer 211A checked based on the memory status signal Memory Status Signal is 320 KB, and the throttle buffer 211A receives the image signals from two image sensors 100 (e.g., shown in FIG. 2), and the number of pieces of data included in one line of the image signal IMS1 (e.g., shown in FIG. 5) is 8192 (for example, K in FIG. 5 is 8192), and the capacity of one data is 14 bits. In this regard, a ratio of the capacity of one line of the image signal to the total capacity of the throttle buffer 211A may be 8.75%.

Accordingly, in some example embodiments, the buffer checking circuit 217 may output the stall counting enable signal STALL_CNT_EN at a logic high, in response to that the ratio of the current usage capacity of the throttle buffer 211A to the total capacity of the throttle buffer 211A is greater than the ratio of the capacity of one line of the image signal IMS1 to the total capacity of the throttle buffer 211A. Therefore, when the ratio of the current usage capacity of the throttle buffer 211A to the total capacity of the throttle buffer 211A exceeds 8.75%, the buffer checking circuit 217 may output the stall counting enable signal STALL_CNT_EN at a logic high.

However, in some example embodiments, a case in which the ratio of the current usage capacity of the throttle buffer 211A to the total capacity of the throttle buffer 211A is equal to or smaller than 8.75% corresponds to a case in which the temporal length of the time-interval (e.g., the time-interval T4) of the stall signal shown in FIG. 7 is smaller than the temporal length of the blank interval Blank1 in the case I (e.g., shown in FIG. 7) where there is no stall signal input to the throttle buffer 211A. For example, when the ratio of the current usage capacity of the throttle buffer 211A to the total capacity of the throttle buffer 211A is smaller than the ratio of the capacity of one line of the image signal IMS1 to the total capacity of the throttle buffer 211A, and even when the stall signal is input to the throttle buffer 211A such that the output of the data signal is delayed, the data may be sufficiently processed before a next line of the image signal IMS1 is input from the image sensor 100.

Therefore, the buffer checking circuit 217 may output the stall counting enable signal STALL_CNT_EN at a logic high in a response to only that the ratio of the current usage capacity of the throttle buffer 211A to the total capacity of the throttle buffer 211A is greater than the ratio of the capacity of one line of the image signal IMS1 to the total capacity of the throttle buffer 211A. The stall counting circuit 218 may receive the stall counting enable signal STALL_CNT_EN at a logic high and thus may count the stall signal Stall Signal.

Next, referring to FIG. 9, FIG. 9 is a timing diagram showing a clock signal clk that toggles at a regular time-interval, the input valid signal Input Valid Signal; I_Valid and the data signal Data Signal; I_DATA input to the throttle buffer 211A, the output valid signal Output Valid Signal; O_Valid and the data signal Data Signal; O_DATA output from the throttle buffer 211A, and the stall signal Stall Signal; I_STALL input to the throttle buffer 211A according to some example embodiments.

The input valid signal I_Valid and the data signal I_DATA input to the throttle buffer 211A, the output valid signal O_Valid and the data signal O_DATA output from the throttle buffer 211A, and the stall signal I_STALL input to the throttle buffer 211A may be counted based on the clock signal clk.

In some example embodiments, assuming that the stall signal I_STALL is not input to the throttle buffer 211A, there is no signal buffering process in the throttle buffer 211A. Thus, the input valid signal I_Valid input to the throttle buffer 211A may be output as the output valid signal O_Valid from the throttle buffer 211A for the same time-interval as a time-interval for which the input valid signal I_Valid is input to the throttle buffer 211A. Likewise, the data signal I_DATA input to the throttle buffer 211A may be output as the data signal O_DATA from the throttle buffer 211A for the same time-interval as a time-interval for which the data signal I_DATA is input to the throttle buffer 211A.

However, in some example embodiments, e.g., as shown in FIG. 9, when the stall signal I_STALL is input to the throttle buffer 211A, an operation of outputting the data signal O_DATA from the throttle buffer 211A may be interrupted for a time-interval T1 for which the stall signal I_STALL is input to the throttle buffer 211A. For example, when the stall signal I_STALL is input to the throttle buffer 211A for the time-interval T1, only data D1 may be output from the throttle buffer 211A for the time-interval T1, and data D2 as next data may not be output from the throttle buffer 211A for the time-interval T1. Afterwards, the next data D2 may be output from a time-point t2 at which the stall signal I_STALL is not input.

Therefore, in some example embodiments, even when a time-point t1 at which first data DO is input to the throttle buffer 211A coincides with a time-point t1 at which the first data DO is output from the throttle buffer 211A, a time-point t5 at which outputting of last data Dn from the throttle buffer 211A has been completed may be later than a time-point t3 at which inputting of the last data Dn into the throttle buffer 211A has been completed. Likewise, even when a time-point t0 at which the valid signal I_Valid input to the throttle buffer 211A transitions to a logic high to the logic low and the time-point t0 at which the valid signal O_Valid output from the throttle buffer 211A transitions from a logic low to a logic high coincide with each other, a time-point t6 at which the valid signal O_Valid output from the throttle buffer 211A transitions from a logic high to a logic low may be later than a time-point t4 at which the valid signal I_Valid input to the throttle buffer 211A transitions from a logic high to a logic low.

In some example embodiments, a time-interval between the time-point t4 at which the input valid signal I_Valid transitions from a logic high to logic low and a time-point t7 at which the input valid signal I_Valid transitions from a logic low to a logic high may correspond to the blank interval Blank1 in FIG. 7. For example, in response to that a temporal length of the time-interval T1 for which the stall signal I_STALL is at a logic high is larger than a temporal length of a time-interval between the time-point t4 and the time-point t7, the stall counting circuit 218 (e.g., shown in FIG. 6) may count the stall signal.

In some example embodiments, when the stall counting circuit 218 receives the stall counting enable signal STALL_CNT_EN at a logic high from the buffer checking circuit 217, the stall counting circuit 218 may count the stall signal Stall Signal input from the path Path 1 based on the clock signal clk.

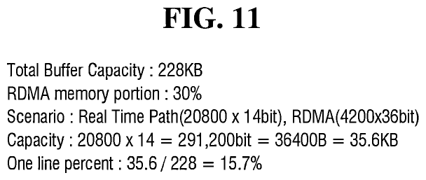

FIG. 10 is an example diagram illustrating a stall counting block according to some example embodiments. FIG. 11 is an example diagram illustrating an operation of the stall counting block in FIG. 10 according to some example embodiments. In following descriptions, those duplicate with the descriptions as set forth above with reference to FIG. 6 will be omitted, and differences therebetween will be mainly described.

First, referring to FIG. 10, the memory status signal Memory Status Signal output by the throttle buffer 211A may further include a RDMA enable signal RDMA_EN, and information RDMA_MEM_PORTION about a usage capacity of the throttle buffer 211A for controlling the throughput of the RDMA 216A (e.g., shown in FIG. 4). Referring to FIG. 4, the RDMA enable signal RDMA_EN may mean that an operation reading, by the throttle buffer 211A, the data stored in the memory 300 using the RDMA 216A has been enabled.

Furthermore, the information RDMA_MEM_PORTION about the usage capacity of the throttle buffer 211A for controlling the throughput of the RDMA 216A may include information about a capacity dedicated to the RDMA 216A of the total capacity of the throttle buffer 211A.

The buffer checking circuit 217A may output the stall counting enable signal STALL_CNT_EN based on the memory status signal Memory Status Signal. For example, the buffer checking circuit 217A may output the stall counting enable signal STALL_CNT_EN at a logic high, in response to that a ratio of the current usage capacity CURRENT_BUF_USAGE of the throttle buffer 211A to the total capacity BUFFER_SIZE of the throttle buffer 211A is greater than a sum of a ratio of the capacity I_WIDTH of one line to the total capacity BUFFER_SIZE of the throttle buffer 211A and the ratio of the usage capacity RDMA_MEM_PORTION of the throttle buffer 211A for controlling the throughput of the RDMA to the total capacity BUFFER_SIZE of the throttle buffer 211A, based on the information included in the received memory status signal Memory Status Signal.

For example, when the throttle buffer 211A reads the data from the memory 300 using the RDMA 216A, the ratio of the usage capacity CURRENT_BUF_USAGE of the throttle buffer 211A to the total capacity BUFFER_SIZE of the throttle buffer 211A may exceed the ratio of the capacity I_WIDTH of one line to the total capacity BUFFER_SIZE of the throttle buffer 211A. However, in this case, even when the data is stored in the throttle buffer 211A, the overflow phenomenon may be less likely to occur, due to the capacity dedicated to the RDMA 216A of the total capacity BUFFER_SIZE of the throttle buffer 211A. Therefore, in some example embodiments, when there is the capacity dedicated to RDMA 216A of the total capacity BUFFER_SIZE of the throttle buffer 211A, the buffer checking circuit 217 may additionally consider the capacity RDMA_MEM_PORTION dedicated to the RDMA 216A of the total capacity BUFFER_SIZE of the throttle buffer 211A when outputting the stall counting enable signal STALL_CNT_EN.

Next, referring to FIG. 11, FIG. 11 is a diagram of an example in which the buffer checking circuit 217A (e.g., shown in FIG. 10) outputs the stall counting enable signal STALL_CNT_EN at a logic high, based on the memory status signal Memory Status Signal, in order to increase the reliability of the stall counting value STALL_CNT_VALUE according to some example embodiments.

For example, the total capacity of the throttle buffer 211A, checked based on the memory status signal Memory Status Signal, may be 228 KB, and the capacity dedicated to the RDMA 216A of the total capacity of the throttle buffer 211A may be set to 30% of the total capacity of the throttle buffer 211A. Furthermore, the capacity of one line of the image signal IMS1 that the throttle buffer 211A receives from the image sensor 100 may be 35.6 KB. Thus, the ratio of the capacity of one line of the image signal to the total capacity of the throttle buffer 211A may be 15.7%. Accordingly, in some example embodiments, a path through which the throttle buffer 211A receives the image signal IMS1 from the image sensor 100 and writes the image signal to the memory 300 using the WDMA 215A without CPU intervention may be a real time path. This may be contrasted with the RDMA 216A which has the non-real time feature.

Therefore, in some example embodiments, the buffer checking circuit 217A may output the stall counting enable signal STALL_CNT_EN at a logic high, in response to only that the ratio of the current usage capacity of the throttle buffer 211A to the total capacity of the throttle buffer 211A exceeds 45.7% as the sum of the ratio 30% of the capacity dedicated to the RDMA 216A to the total capacity of the throttle buffer 211A and the ratio 15.7% of the capacity of one line of the image signal to the total capacity of the throttle buffer 211A. Accordingly, in some example embodiments, the stall counting circuit 218A may count the stall signal Stall Signal only when the actual possibility of the overflow is high. Thus, the reliability of the stall counting value STALL_CNT_VALUE may be improved.

FIG. 12 and FIG. 13 are example diagrams illustrating a stall counting block according to some example embodiments.

First, referring to FIG. 12, III is a graph of the usage capacity of the throttle buffer 211A when the capacity of one line of the image signal IMS1 input to the throttle buffer 211A (e.g., shown in FIG. 2) is relatively small. Still referring to FIG. 12, IV is a graph showing the usage capacity of the throttle buffer 211A when the capacity of one line of the image signal IMS1 input to the throttle buffer 211A is relatively large. First, referring to III, a time-interval for which the usage capacity of the throttle buffer 211A increases may be a time-interval for which the image signal IMS1 is input from the image sensor 100 to the throttle buffer 211A. Furthermore, a time-interval for which the usage capacity of the throttle buffer 211A decreases may be a time-interval for which the image signal IMS1 output from the image sensor 100 and stored in the throttle buffer 211A is output.

For example, the capacity of one line of the image signal IMS1 may be relatively small. In this case, even when an operation in which multiple image signals IMS1 are input to the throttle buffer 211A is repeated several times, a component (for example, the module or the sub-IP, in rear of the throttle buffer 211A may quickly process the image signal because the capacity of the image signals are small. Therefore, in some example embodiments, the stall counting value STALL_CNT_VALUE may be large, compared to the fact that the current usage capacity of the throttle buffer 211A may not be large (e.g., a ratio of a capacity in which the data is stored to the total capacity of the throttle buffer 211A is not large).

Referring to IV in which the capacity of one line of the image signal is relatively large, even when only one image signal IMS1 is input to the throttle buffer 211A, the total capacity of the throttle buffer 211A may be filled immediately. However, in this case, although the possibility at which the overflow phenomenon occurs is greater than that in III, the stall counting value STALL_CNT_VALUE may be smaller than that in III.

Therefore, in some example embodiments, when counting the stall signal Stall Signal, the stall counting block 214A should consider the temporal length of one line of the image signal IMS1 input from the image sensor 100 to ensure that the reliability of the stall counting value STALL_CNT_VALUE is higher.

Next, referring to FIG. 13, the stall counting block 214A-2 may include a throughput checking circuit 219 and the stall counting circuit 218B. In following descriptions, those duplicate with the descriptions as set forth above with reference to FIG. 6 will be omitted, and differences therebetween will be mainly described.

The throughput checking circuit 219 may receive the period signal Period Signal of the image signal IMS1 from the throttle buffer 211A, and may receive the output valid signal Output Valid Signal of the image signal IMS1 through the path Path 1. However, example embodiments of the present inventive concepts are not limited thereto, and the period signal Period Signal and the output valid signal Output Valid Signal may be transmitted from the throttle buffer 211A to the throughput checking circuit 219 without passing through the path Path 1. Alternatively, in some example embodiments, both the period signal Period Signal and the output valid signal Output Valid Signal may be transmitted from the throttle buffer 211A to the throughput checking circuit 219 via the path Path 1.

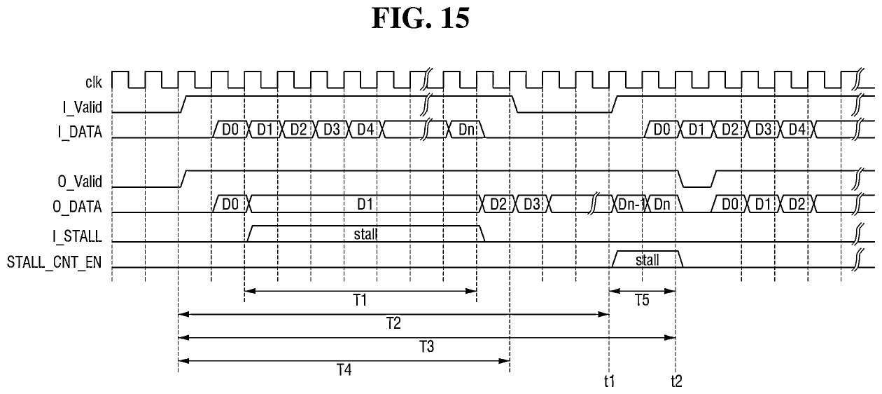

The throughput checking circuit 219 may output the stall counting enable signal STALL_CNT_EN based on the period signal Period Signal and the output valid signal Output Valid Signal of the image signal IMS1. The period signal Period Signal and the output valid signal Output Valid Signal of the image signal IMS1 may include information about the capacity of one line of the image signal IMS1. An operation in which the throughput checking circuit 219 outputs the stall counting enable signal STALL_CNT_EN based on the period signal Period Signal and the output valid signal Output Valid Signal of the image signal IMS1, according to some example embodiments, will be described later with reference to FIG. 14 and FIG. 15.

FIG. 14 and FIG. 15 are example diagrams illustrating the operation of the stall counting block in FIG. 13 according to some example embodiments.

First, referring to FIG. 14, each of V, VI, and VII is a timing diagram showing the output valid signal Output Valid Signal output from the throttle buffer 211A and the stall signal Stall Signal input to the throttle buffer 211A. First, referring to V, a period signal Period1 corresponding to the first line Line1 (e.g., shown in FIG. 5) of the image signal IMS1 may be a signal as a sum of a time-interval T1 for which the output valid signal Output Valid Signal of the image signal IMS1 is first at a logic high and a blank interval Blank1 for which the output valid signal Output Valid Signal of the image signal IMS1 is first at a logic low. A period signal Period2 corresponding to the second line Line2 (e.g., shown in FIG. 5) of the image signal IMS1 may be a signal as a sum of a time-interval T2 for which the output valid signal Output Valid Signal of the image signal IMS1 is second at a logic high and a blank interval Blank2 for which the output valid signal Output Valid Signal of the image signal IMS1 is second at a logic low.

The period signal of the image signal IMS1 may correspond to each of the lines included in the image signal IMS1. For example, the period signal of the image signal IMS1 may indicate a timing at which one line of the image signal IMS1 is input to the throttle buffer 211A.

Next, referring to VI, when the stall signal Stall Signal is input to the throttle buffer 211A, a time-interval T3 for which the output valid signal Output Valid Signal is at a logic high may be increased compared to the time-interval T1 in V in which the stall signal Stall Signal is not input to the throttle buffer 211A. However, in some example embodiments, the period signal Period1 of the image signal IMS1 may be a value predetermined based on the specifications of the image sensor 100 that generates the image signal IMS1. Thus, in some example embodiments, although the time-interval T3 for which the output valid signal Output Valid Signal is at a logic high increases such that a temporal length of a blank interval Blank3 relatively decreases compared to a temporal length of the blank interval Blank1 in V, a temporal length of the period signal Period1 of the image signal IMS1 may be constant. For example, the number of clocks for a time-interval for which the period signal Period1 of the image signal IMS1 is output from the throttle buffer 211A may be constant.

Likewise, in some example embodiments, even when the stall signal Stall Signal is input to the throttle buffer 211A, a temporal length of the period signal Period2 corresponding to the second line Line2 of the image signal IMS1 is constant. Thus, although a temporal length of a time-interval T4 for which the output valid signal Output Valid Signal is at a logic high increases compared to a temporal length of the time-interval T2 in V such that the temporal length of the blank interval Blank4 relatively decreases compared to the temporal length of the time-interval Blank2 in V, the number of clocks for a time-interval for which the period signal Period2 of the image signal IMS1 is output from the throttle buffer 211A may be constant.

As will be described later with reference to FIG. 15, in some example embodiments, the throughput checking circuit 219 may count the number of clocks in the period signal Period and the number of clocks for the time-interval for which the output valid signal Output Valid Signal is at a logic high. However, in some example embodiments, the throughput checking circuit 219 may not count the number of the clocks of the output valid signal Output Valid Signal for a time-interval for which the stall signal Stall Signal is at a logic high. For example, while the stall signal Stall Signal is input to the throttle buffer 211A, the throttle buffer 211A does not output an image signal IMS1. Thus, for the time-interval for which the stall signal Stall Signal is input to the throttle buffer 211A, the throughput checking circuit 219 may not count the number of clocks of the output valid signal Output Valid Signal.

In VI, illustrated in FIG. 14, the stall signal Stall Signal is input to the throttle buffer 211A, but a temporal length of a time-interval T5 for which the stall signal Stall Signal is input to the throttle buffer 211A is not large. Thus, before a time-point t1 at which the output valid signal Output Valid Signal corresponding to the second line Line2 of the image signal IMS1 transitions from a logic low to a logic high, the output valid signal Output Valid Signal corresponding to the first line Line1 of the image signal IMS1 may transition from a logic high to a logic low at a time-point t0.

For example, at a time-point t0 at which the throughput checking circuit 219 has counted all the clock numbers of the output valid signal Output Valid Signal corresponding to the first line Line1 of the image signal IMS1, there may still be further clocks left to be counted of the period signal Period1 corresponding to the first line Line1 of the image signal IMS1.

For example, before the time-point t1 at which the second line Line2 of the image signal IMS1 is input to the throttle buffer 211A, all of the data corresponding to the first line Line1 of the image signal IMS1 have been outputted from the throttle buffer 211A at the time-point t0. Before the second line Line2 of the image signal IMS1 is input to the throttle buffer 211A, a blank interval Blank3 remains for which no data or image signal from the image sensor 100 is input to the throttle buffer 211A. Thus, the possibility of which the overflow occurs may not be high. Accordingly, in some example embodiments, the throughput checking circuit 219 may output the stall counting enable signal STALL_CNT_EN at a logic low.

However, in some example embodiments such as in VII, a temporal length of a time-interval T8 for which the stall signal Stall Signal is input to the throttle buffer 211A becomes larger. Thus, a blank interval may be absent between a time-interval T6 for which the output valid signal Output Valid Signal corresponding to the first line Line1 of the image signal IMS1 is at a logic high and a time-interval T7 for which the output valid signal Output Valid Signal corresponding to the second line Line2 is at a logic high.

For example, before the throughput checking circuit 219 has completed the operation of counting the number of the clocks of the output valid signal Output Valid Signal corresponding to the first line Line1 of the image signal IMS1, the throughput checking circuit 219 may have counted all of the number of clocks of the period signal Period1 corresponding to the first line Line1 of the image signal IMS1.

For example, the throughput checking circuit 219 counting the number of clocks of the output valid signal Output Valid Signal may mean the throughput checking circuit 219 counting the number of clocks for a remaining portion of a time-interval for which the output valid signal Output Valid Signal is at a logic high, except for a portion of the time-interval for which the output valid signal Output Valid Signal is at a logic high and the stall signal Stall Signal is at a logic high. For example, the throughput checking circuit 219 may not count the number of clocks of the output valid signal Output Valid Signal for a time-interval T8 for which the stall signal Stall Signal is at a logic high, within the time-interval T6 for which the output valid signal Output Valid Signal corresponding to the first line Line1 of the image signal IMS1 is at a logic high.

Accordingly, in some example embodiments, the throughput checking circuit 219 may output the stall counting enable signal STALL_CNT_EN at a logic high, in response to that counting of the number of the clocks of the period signal Period Signal has been completed before all of the number of the clocks of the output valid signal Output Valid Signal have been counted.

For example, a time-interval T9 from a time-point t1 at which an operation in which the period signal Period1 corresponding to the first line Line1 of the image signal IMS1 is output from the throttle buffer 211A ends to a time-point t2 at which an operation in which the output valid signal Output Valid Signal corresponding to the first line Line1 of the image signal IMS1 is output from the throttle buffer 211A ends may be a time-interval that affects the overflow phenomenon of the throttle buffer 211A. For example, a time-interval from a time-point at which the throughput checking circuit 219 has competed counting of the period signal Period1 corresponding to the first line Line1 of the image signal IMS1 to a time-point at which the throughput checking circuit 219 has completed counting of the output valid signal Output Valid Signal corresponding to the first line Line1 of the image signal IMS1 may be a time-interval that actually affects the overflow phenomenon of the throttle buffer 211A.

Next, referring to FIG. 15, FIG. 15 is a timing diagram showing the clock signal clk that toggles at a regular time-interval, the input valid signal Input Valid Signal; I_Valid and the data signal Data Signal; I_DATA input to the throttle buffer 211A, the output valid signal Output Valid Signal; O_Valid and the data signal Data Signal; O_DATA output from the throttle buffer 211A, the stall signal Stall Signal; I_STALL input to the throttle buffer 211A, and the stall counting enable signal STALL_CNT_EN output from the throughput checking circuit 219 according to some example embodiments.

The input valid signal I_Valid and the data signal I_DATA input to the throttle buffer 211A, the output valid signal O_Valid and the data signal O_DATA output from the throttle buffer 211A, and the stall signal I_STALL input to the throttle buffer 211A may be counted based on the clock signal clk. Furthermore, in some example embodiments, in response to that the throughput checking circuit 219 outputs the stall counting enable signal STALL_CNT_EN at a logic high, the stall counting circuit 218B which counts the stall signal Stall Signal may count the stall signal Stall Signal based on the clock signal clk.

As shown in FIG. 15, in some example embodiments, when the stall signal I_STALL is input to the throttle buffer 211A, an operation of outputting the data signal O_DATA from the throttle buffer 211A may be interrupted for a time-interval T1 for which the stall signal I_STALL is input to the throttle buffer 211A. Accordingly, in some example embodiments, a time-interval T2 corresponding to the period signal Period Signal defined as a sum of a time-interval T4 for which the input valid signal I_Valid input to the throttle buffer 211A is at a logic high and a time-interval for which the valid signal Valid Signal is at a logic low may be constant. However, in some example embodiments, a time-interval T3 for which the output valid signal O_Valid output from the throttle buffer 211A is at a logic high may be increased compared to a time-interval T4 for which the input valid signal I_Valid input to the throttle buffer 211A is at a logic high.

For example, a time-interval T5 from a time-point t1 at which the period signal Period1 (e.g., shown in FIG. 14) corresponding to the first line Line1 of the image signal IMS1 transitions from a logic high to a logic low to a time-point t2 at which the output valid signal O_Valid corresponding to the first line Line1 of the image signal IMS1 transitions from a logic high to a logic low may be a time-interval that actually affects the overflow phenomenon of the throttle buffer 211A. Accordingly, in some example embodiments, the stall counting circuit 218B may count the number of clocks for the time-interval T5 in response to receiving the stall counting enable signal STALL_CNT_EN at a logic high from the throughput checking circuit 219. For example, the number of clocks for the time-interval T5 may correspond to the stall counting value STALL_CNT_VALUE output from the stall counting circuit 218B.

FIG. 16 and FIG. 17 are example diagrams illustrating stall counting blocks according to some example embodiments. Hereinafter, stall counting blocks 214A-3 and 214A-4 according to some example embodiments will be described with reference to FIG. 16 and FIG. 17. Furthermore, descriptions that duplicate with those set forth above with reference to the previous example embodiments are omitted.

Each of the buffer checking circuit 217 and the throughput checking circuit 219 may generate the stall counting enable signal STALL_CNT_EN. If the stall counting enable signals STALL_CNT_EN respectively generated by the buffer checking circuit 217 and the throughput checking circuit 219 are at a logic low, the stall counting circuit 218C may not perform a stall counting operation.

If any one of the stall counting enable signals STALL_CNT_EN respectively generated by the buffer checking circuit 217 and the throughput checking circuit 219 is at a logic high, the stall counting circuit 218C may receive the stall counting enable signal STALL_CNT_EN at the logic high as generated and may count the stall signal Stall Signal input from the path Path 1 based on the stall counting enable signal STALL_CNT_EN at the logic high.

If both the stall counting enable signals STALL_CNT_EN respectively generated by the buffer checking circuit 217 and the throughput checking circuit 219 are at a logic high, the multiplexer 220 may be enabled based on a multiplexer enable signal MUX_EN and may select one of the stall counting enable signal STALL_CNT_EN output from the buffer checking circuit 217 and the stall counting enable signal STALL_CNT_EN output from the throughput checking circuit 219. The multiplexer 220 may transmit the selected one of the stall counting enable signals STALL_CNT_EN to a stall counting circuit 218C. The stall counting circuit 218C may count the stall signal input from the path Path 1 based on the selected one.

For example, when the stall counting circuit 218C is enabled based on the stall counting enable signal STALL_CNT_EN output from the buffer checking circuit 217, the stall counting circuit 218C may count the stall signal Stall Signal based on the method as described with reference to FIG. 6 to FIG. 9.

Conversely, in some example embodiments, when the stall counting circuit 218C is enabled based on the stall counting enable signal STALL_CNT_EN output from the throughput checking circuit 219, the stall counting circuit 218C may count the stall signal Stall Signal based on the method described with reference to FIG. 13 to FIG. 15.

Next, referring to FIG. 17, in some example embodiments, the buffer checking circuit 217A may additionally receive the RDMA enable signal RDMA_EN and the information RDMA_MEM_PORTION about the usage capacity of the throttle buffer 211A to control the throughput of the RDMA 216A (e.g., shown in FIG. 4) from the throttle buffer 211A. Accordingly, in some example embodiments, when a stall counting circuit 218D is enabled based on the stall counting enable signal STALL_CNT_EN received from the buffer checking circuit 217A, the buffer checking circuit 217A may determine whether to count the stall signal Stall Signal, based on the capacity dedicated to the RDMA 216A of the total capacity of the throttle buffer 211A, as described with reference to FIG. 10 to FIG. 11.

FIG. 18 is an example diagram illustrating a system-on-chip included in an electronic device according to some example embodiments.

Referring to FIG. 18, a system-on-chip 500 may be a system-on-chip included in the electronic device 1000 in FIG. 1. The system-on-chip 500 may include an interconnect 501, a plurality of functional blocks 510, 515, 520, 525, 530, 540, 550, 560, 570, and 580, a first memory device 535, a display 545, a second memory device 555, and a camera 575. The image signal processor 200 (e.g., shown in FIG. 1) may be any one of the plurality of functional blocks 510, 515, 520, 525, 530, 540, 550, 560, 570, and 580.

According to some example embodiments, the electronic device 1000 may be embodied as a PC or a mobile device, but example embodiments are not limited thereto. The mobile device may be embodied as a laptop computer, a mobile phone, a smartphone, a tablet PC, a personal digital assistant (PDA), an enterprise digital assistant (EDA), a digital still camera, and a digital video camera, a portable multimedia player (PMP), PND (a personal navigation device or a portable navigation device), a handheld game console, a mobile internet device (MID), a wearable computer, an IoT (Internet of things) device, an IoE (internet of everything) device, a drone, or a e-book, but example embodiments are not limited thereto.

The CPU 510 may control an operation of each of the plurality of functional blocks 515, 520, 525, 530, 540, 550, 560, 570, and 580 via the interconnect 501. For example, the interconnect 501 may be embodied as a bus. The communication module 515 may control data exchange between an external communication device and the electronic device 1000. For example, the communication module 515 may include a transceiver 515-1 for Bluetooth communication, a transceiver 515-2 for Wi-Fi communication, and a GPS receiver 515-3 for receiving a GPS signal. Data processed by the communication module 515 may be transmitted through the interconnect 501 to at least one of the plurality of functional blocks 510, 515, 520, 525, 530, 540, 550, 560, 570, and 580. For example, the bus 400 (e.g., shown in FIG. 1) may correspond to the interconnect 501.

The GPU 520 may process graphics data. The input/output interface 525 may transmit data input from the user to the interconnect 501 or transmit data transmitted from the interconnect 501 to an input/output device. The first memory controller 530 may write data to or read data from the first memory device 535 under control of the CPU 510 or the GPU 520. For example, the first memory device 535 may be a non-volatile memory device. The display controller 540 may control an operation of the display 545 under the control of the CPU 510 or the GPU 520. For example, the display controller 540 may transmit display data to the display 545.

The second memory controller 550 may write data to or read data from the second memory device 555 under the control of the CPU 510 or the GPU 520. For example, the second memory device 555 may be a volatile memory device. The memory 300 (e.g., shown in FIG. 1) may be either the first memory device 535 or the second memory device 555.

The USB controller 560 may send or receive data to or from a USB host. The camera controller 570 may process data output from the camera 575 and transmit the processed data to the interconnect 501. The image sensor 100 (e.g., shown in FIG. 1) may be mounted on the camera 575.

The debug controller 580 may control debugging of the system-on-chip 500. For example, upon observation that the frame drop has occurred in the image signal processor 200 (e.g., shown in FIG. 1), the debug controller 580 may determine that an overflow phenomenon has occurred in the image signal processor 200. In some example embodiments, based on the frame drop phenomenon, the debug controller 580 may determine that the phenomenon in which the image signal is stuck in the data path within the image signal processor 200 has worsened or deteriorated because a rate at which the throttle buffer 211A (e.g., shown in FIG. 2) included in the sub-IP 210-1 (e.g., as shown in FIG. 2) as the frontmost sub-IP among the plurality of sub-IPs included in the image signal processor 200 buffers and outputs the image signal received from the image sensor 100 in real time is higher than a rate at which the modules or other sub-IPs positioned in rear of the throttle buffer 211A receive and process the image signal.

Accordingly, in some example embodiments, the debug controller 580 may check the stall counting status signal STALL_CNT_STATUS and the stall counting value STALL_CNT_VALUE generated by each of the stall counting blocks 214A and 214B (e.g., shown in FIG. 2) included in each of the plurality of sub-IPs 210-1 and 210-2 (e.g., shown in FIG. 2), and may find the data path that causes the overflow phenomenon based on the checking result. For example, the debug controller 580 may determine sub-IPs that output the stall counting status signal STALL_CNT_STATUS at a logic high among the plurality of sub-IPs of the image signal processor 200, and compare the counting values STALL_CNT_VALUE respectively outputted from the determined sub-IPs from each other. Then, the debug controller 580 may first determine whether the image signal is stuck or whether the image signal has overflowed, in the sub-IP that is outputting the highest stall counting value STALL_CNT_VALUE, based on the comparing result. Then, the debug controller 580 may determine whether the image signal is stuck or whether the image signal has overflowed, in the sub-IP that is outputting the second highest stall counting value STALL_CNT_VALUE.

One or more of the elements disclosed above may include or be implemented in one or more processing circuitries such as hardware including logic circuits; a hardware/software combination such as a processor executing software or a combination thereof. For example, the processing circuitries more specifically may include, but are not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a non-transitory computer readable medium and may store a program of instructions. Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Although some example embodiments of the present inventive concepts have been described with reference to the accompanying drawings, example embodiments of the present inventive concepts are not limited to the above example embodiments, but may be implemented in various different forms. A person skilled in the art may appreciate that the present inventive concepts may be practiced in other concrete forms without changing the technical spirit or essential characteristics of the present inventive concepts. Therefore, it should be appreciated that the example embodiments as described above are not restrictive but are illustrative in all respects.

What is claimed is:

1. An image signal processor, comprising:
a first throttle buffer configured to receive first to third image signals from an image sensor, buffer the first to third image signals, and output the buffered first to third image signals, the first image signal including at least one first line;
a first module configured to receive the first to third image signals, perform a first calculation on each of the first to third image signals, and output first to third calculated image signals corresponding to the first to third image signals, respectively;
a first splitter configured to receive the first to third calculated image signals, split the first to third calculated image signals, and send the first calculated image signal to a first path;
a first buffer checking circuit configured to
receive a first memory status signal from the first throttle buffer including information about a capacity of the first line, a total capacity of the first throttle buffer, and a usage capacity of the first throttle buffer, and
output a first stall counting enable signal at a logic high, in response to a ratio of the usage capacity of the first throttle buffer to the total capacity of the first throttle buffer being greater than a ratio of the capacity of the first line to the total capacity of the first throttle buffer; and
a first stall counting circuit configured to count a first stall signal input from the first path, in response to receiving the first stall counting enable signal at a logic high.

2. The image signal processor of claim 1, wherein the first splitter is configured to split the first to third calculated image signals, and send the second and third calculated image signals to a second path,
wherein the image signal processor further comprises:
a second throttle buffer configured to receive the second and third calculated image signals through the second path, buffer the second and third calculated image signals, and output the buffered second and third calculated image signals;
a second module configured to receive the second and third calculated image signals, perform a second calculation on each of the second and third calculated image signals, and output fourth and fifth calculated image signals respectively corresponding to the second and third calculated image signals; and
a second splitter configured to receive the fourth and fifth calculated image signals, split the fourth and fifth calculated image signals, and send the fourth calculated image signal to a third path.

3. The image signal processor of claim 2, wherein the second module is configured to send the first stall signal to the first path.

4. The image signal processor of claim 2, wherein the second throttle buffer is configured to send the first stall signal to the first path.

5. The image signal processor of claim 2, further comprising:
a second buffer checking circuit configured to receive a second memory status signal from the second throttle buffer and output a second stall counting enable signal based on the second memory status signal; and
a second stall counting circuit configured to count a second stall signal input from the third path, in response to receiving the second stall counting enable signal at a logic high.

6. The image signal processor of claim 5, wherein the second calculated image signal includes at least one second line,
wherein the second memory status signal includes information about a capacity of the second line, a total capacity of the second throttle buffer, and a usage capacity of the second throttle buffer.

7. The image signal processor of claim 6, wherein the second buffer checking circuit is configured to output the second stall counting enable signal at a logic low, in response to a ratio of the capacity of the second line to the total capacity of the second throttle buffer being smaller than a ratio of the usage capacity of the second throttle buffer to the total capacity of the second throttle buffer.

8. The image signal processor of claim 6, further comprising a RDMA (Read Direct Memory Access) to an external memory,
wherein the second memory status signal includes information about a usage capacity of the second throttle buffer for controlling a throughput of the RDMA.

9. The image signal processor of claim 8, wherein the second buffer checking circuit is configured to output the second stall counting enable signal at a logic high, in response to a ratio of the usage capacity of the second throttle buffer to the total capacity of the second throttle buffer being greater than a sum of a ratio of the capacity of the second line to the total capacity of the second throttle buffer, and a ratio of the usage capacity of the second throttle buffer for controlling the throughput of the RDMA to the total capacity of the second throttle buffer.

10. The image signal processor of claim 2, further comprising:
a throughput checking circuit configured to receive a period signal and a valid signal of the second calculated image signal from the second throttle buffer, and output a second stall counting enable signal based on the period signal and the valid signal; and
a second stall counting circuit configured to count a second stall signal input from the third path, in response to receiving the second stall counting enable signal at a logic high.

11. The image signal processor of claim 10, wherein the second calculated image signal includes an N-th line and an (N+1)-th line subsequent to the N-th line,
wherein the period signal of the second calculated image signal includes information about a first time-point at which the N-th line of the second calculated image signal is input to the second throttle buffer and a second time-point at which the (N+1)-th line of the second calculated image signal is input to the second throttle buffer,
wherein the valid signal of the second calculated image signal includes information about a third time-point at which the N-th line of the second calculated image signal is output from the second throttle buffer.

12. An image signal processor comprising:
a first throttle buffer configured to receive first to third image signals from an image sensor, buffer the first to third image signals, and output the buffered first to third image signals, the first image signal including an N-th line and an (N+1)-th line subsequent to the N-th line;
a first module configured to receive the first to third image signals, perform a first calculation on each of the first to third image signals, and output first to third calculated image signals respectively corresponding to the first to third image signals;
a first splitter configured to receive the first to third calculated image signals, split the first to third calculated image signals, and send the first calculated image signal to a first path;
a throughput checking circuit configured to
receive a period signal of the first image signal from the first throttle buffer including information about a first time-point at which the N-th line of the first image signal is input to the first throttle buffer and a second time-point at which the (N+1)-th line of the first image signal is input into the first throttle buffer, and a valid signal of the first image signal from the first throttle buffer including information about a third time-point at which the N-th line of the first image signal is output from the first throttle buffer, and
output a first stall counting enable signal at a logic high, in response to the second time-point being earlier than the third time-point; and
a first stall counting circuit configured to count a first stall signal input from the first path, in response to receiving the first stall counting enable signal at a logic high.

13. The image signal processor of claim 12, wherein the N-th line of the first image signal includes first to M-th data,
wherein the valid signal of the first image signal includes a first valid signal corresponding to the N-th line of the first image signal,
wherein the first valid signal transitions from a logic low to a logic high at a fourth time-point, and transitions from a logic high to a logic low at a fifth time-point after the fourth time-point,
wherein the first throttle buffer is configured to output the first data at a sixth time-point, and to output the M-th data at the third time-point after the sixth time-point,
wherein the sixth time-point coincides with, or is earlier than, the fourth time-point, and
wherein the third time-point coincides with, or is earlier than, the fifth time-point.

14. The image signal processor of claim 13, wherein the first stall counting circuit is configured to count the first stall signal input from the first path for a time-interval from the second time-point to the fifth time-point.

15. The image signal processor of claim 12, wherein the first splitter is configured to split the first to third calculated image signals and send the second and third calculated image signals to a second path,
wherein the image signal processor further comprises:
a second throttle buffer configured to receive the second and third calculated image signals through the second path, buffer the second and third calculated image signals, and output the buffered second and third calculated image signals;
a second module configured to receive the second and third calculated image signals, perform a second calculation on each of the second and third calculated image signals, and output fourth and fifth calculated image signals respectively corresponding to the second and third calculated image signals; and
a second splitter configured to receive the fourth and fifth calculated image signals, split the fourth and fifth calculated image signals, and send the fourth calculated image signal to a third path.

16. The image signal processor of claim 15, wherein at least one of the second throttle buffer or the second module is configured to send the first stall signal to the first path.

17. The image signal processor of claim 15, further comprising:
a buffer checking circuit configured to receive a memory status signal from the second throttle buffer and output a second stall counting enable signal based on the memory status signal; and
a second stall counting circuit configured to count a second stall signal input from the third path, in response to receiving the second stall counting enable signal at a logic high.

18. The image signal processor of claim 17, wherein the second calculated image signal includes at least one first line,
wherein the memory status signal includes information about a capacity of the first line, a total capacity of the second throttle buffer, and a usage capacity of the second throttle buffer.

19. The image signal processor of claim 18, wherein the buffer checking circuit is configured to output the second stall counting enable signal at a logic high, in response to a ratio of the usage capacity of the second throttle buffer to the total capacity of the second throttle buffer being greater than a ratio of the capacity of the first line to the total capacity of the second throttle buffer.

20. An image signal processor comprising:
a throttle buffer configured to receive a first image signal from an image sensor, buffer the first image signal, and output the buffered first image signal;
a first module configured to receive the first image signal, perform a first calculation on the first image signal to generate a second image signal, and output the second image signal;
a first splitter configured to receive the second image signal, split the second image signal, and send a third image signal corresponding to part of the second image signal to a first path, the third image signal including an N-th line and an (N+1)-th line subsequent to the N-th line;
a buffer checking circuit configured to
receive a memory status signal from the throttle buffer including information about a capacity of one line included in the third image signal, a total capacity of the throttle buffer, and a usage capacity of the throttle buffer, and
output a first stall counting enable signal at a logic high, in response to a ratio of the usage capacity of the throttle buffer to the total capacity of the throttle buffer being greater than a ratio of the capacity of one line included in the third image signal to the total capacity of the throttle buffer;
a throughput checking circuit configured to
receive a period signal of the third image signal from the throttle buffer including information about a first time-point at which the N-th line of the third image signal is input to the throttle buffer and a second time-point at which the (N+1)-th line of the third image signal is input to the throttle buffer, and a valid signal of the third image signal from the throttle buffer including information about a third time-point at which the N-th line of the third image is output from the throttle buffer, and
output a second stall counting enable signal at a logic high, in response to the second time-point of the third image signal being earlier than the third-time point of the third image signal; and
a stall counting circuit configured to count a stall signal input from the first path, in response to receiving one of the first stall counting enable signal at a logic high and the second stall counting enable signal at a logic high.
